(19) United States
(12) Patent Application Publication
(10) Pub. No.: US 2015/0341499 A1
(43) Pub. Date: Nov. 26, 2015

(54) METHOD AND SYSTEM FOR MANAGING VOICE CALLS IN ASSOCIATION WITH SOCIAL MEDIA CONTENT

(71) Applicant: Hootsuite Media Inc., Vancouver (CA)

(72) Inventors: Stanislav Korsei, Vancouver (CA); Oleksandr Zadorozhnyi, Vancouver (CA)

(73) Assignee: HOOTSUITE MEDIA INC., Vancouver (CA)

(21) Appl. No.: 14/713,239

(22) Filed: May 15, 2015

Related U.S. Application Data
(60) Provisional application No. 62/000,949, filed on May 20, 2014.

(51) Int. Cl. H04M 7/00; G06F 17/30; H04L 12/58; H04M 3/42; G06F 17/22; H04L 29/08

(52) U.S. Cl. CPC H04M 7/003; G06F 17/2235; H04L 67/02; H04L 51/32; H04M 3/4211; G06F 17/30882

(57) ABSTRACT

A computer-implemented method and system for managing voice calls in association with social media content is provided. The method involves: (a) in response to a social-media content piece, posting a replying social-media content piece containing a hyperlink for presenting at least one option for making a voice call having a call identification associated with said social-media content piece; (b) determining said call identification in response to receiving a selection of said at least one option; and (c) forwarding said voice call to a call recipient.

### BACKGROUND OF THE INVENTION

1. Field of Invention

This invention relates to telecommunications and, in particular, to a method and system for managing voice calls in association with social media content.

2. Description of Related Art

Social networking services are Internet-based services permitting users to publish user-generated or other social media content. The users of a social networking service are typically registered account holders having account credentials, including a user identification associated with the social networking service. Many social networking services permit users to publish user-generated content or other social media content in reply to previously published social media content, thereby establishing a thread of social media content. Some social networking services permit users to privately transmit social media content such as messages to specified recipients.

Voice calling involves the transmission by analog and/or digital telecommunications equipment of the human voice, synthetic speech, audio information or other sound, either in real-time or following audio recording. The Public Switched Telephone Network (PSTN) is a standardized telephone system operating globally by circuit-switched telephone networks to provide voice calling services. In contrast to PSTN, Voice over Internet Protocol (VoIP) services employ Internet-based technology to provide voice calling services. Some VoIP services are provided by a stand-alone application, while browser-based VoIP services are provided via a web page of the World-Wide Web.

However, conventional social networking services, PSTN services, and VoIP services do not effectively manage voice calls in association with social media content.

An object of the invention is to address the above shortcomings.

### SUMMARY

The above shortcomings may be addressed by providing, in accordance with one aspect of the invention, a method of managing voice calls in association with social media content. The method involves: (a) presenting, in response to a social-media content piece, at least one option for making a voice call having a call identification associated with the social-media content piece; (b) determining, in response to receiving a selection of the at least one option, the call identification; and (c) forwarding the voice call to a call recipient.

Presenting, in response to a social-media content piece, at least one option for making a voice call having a call identification associated with the social-media content piece may involve presenting at least one technology option for making the voice call. Presenting, in response to a social-media content piece, at least one option for making a voice call having a call identification associated with the social-media content piece may involve presenting a plurality of options for making the voice call. Presenting, in response to a social-media content piece, at least one option for making a voice call having a call identification associated with the social-media content piece may involve presenting a plurality of technology options for making the voice call.

Presenting, in response to a social-media content piece, at least one option for making a voice call having a call identification associated with the social-media content piece may involve presenting the at least one option in response to the social-media content piece associated with a social networking service. Presenting, in response to a social-media content piece, at least one option for making a voice call having a call identification associated with the social-media content piece may involve presenting the at least one option via the social networking service. Presenting, in response to a social-media content piece, at least one option for making a voice call having a call identification associated with the social-media content piece may involve presenting the at least one option via a second social networking service. Presenting, in response to a social-media content piece, at least one option for making a voice call having a call identification associated with the social-media content piece may involve presenting the at least one option via a plurality of social networking services. Presenting the at least one option via a plurality of social networking services may involve presenting the at least one option via the social networking service.

Presenting, in response to a social-media content piece, at least one option for making a voice call having a call identification associated with the social-media content piece may involve presenting the at least one option for making the voice call having the call identification stored in a database containing reference to the social-media content piece. Presenting, in response to a social-media content piece, at least one option for making a voice call having a call identification associated with the social-media content piece may involve presenting the at least one option for making the voice call having the call identification stored in the database containing a copy of the social-media content piece. Presenting, in response to a social-media content piece, at least one option for making a voice call having a call identification associated with the social-media content piece may involve presenting the at least one option for making the voice call having the call identification stored in the database storing the call identification and the copy in association with each other.

Presenting, in response to a social-media content piece, at least one option for making a voice call having a call identification associated with the social-media content piece may involve storing meta-data associated with the social-media content piece. Presenting, in response to a social-media content piece, at least one option for making a voice call having a call identification associated with the social-media content piece may involve storing the meta-data in the database. Storing meta-data associated with the social-media content piece may involve storing identification information associated with a source of the social-media content piece. Storing identification information associated with a source of the social-media content piece may involve retrieving a user identification associated with the social-media content piece. Storing identification information associated with a source of the social-media content piece may involve storing the user identification. Retrieving a user identification associated with the social-media content piece may involve retrieving a social media handle. Storing identification information associated with a source of the social-media content piece may involve storing the social media handle. Retrieving a user identification associated with the social-media content piece may involve retrieving an image associated with the social-media content piece. Storing identification information associated with a source of the social-media content piece may involve storing the image. Retrieving a user identification associated with the social-media content piece may involve obtaining a video recording associated with the social-media content piece. Storing identification information associated with a source of the social-media content piece may involve storing the video recording. Storing meta-data associated with the social-media content piece may involve storing Internet-accessible information associated with the source. Storing Internet-accessible information associated with the source may involve searching for the Internet-accessible information containing the user identification. Storing Internet-accessible information associated with the source may involve searching for social-media content containing the user identification. Storing Internet-accessible information associated with the source may involve storing an image associated with the source. Storing Internet-accessible information associated with the source may involve storing a video recording associated with the source. Storing meta-data associated with the social-media content piece may involve analyzing the social-media content piece. Analyzing the social-media content piece may involve linguistically analyzing the social-media content piece to determine a categorization of meaning associated with the social-media content piece.

Storing meta-data associated with the social-media content piece may involve storing one or more identifications of one or more of the social networking services associated with the social-media content piece, respectively. Storing meta-data associated with the social-media content piece may involve storing a publication time at which the social-media content piece was published. Storing a publication time at which the social-media content piece was published may involve storing a publication date. Storing meta-data associated with the social-media content piece may involve storing the publication time at which the social-media content piece was published via each of the one or more social networking services. Storing meta-data associated with the social-media content piece may involve storing an identification associated with the call recipient.

Storing meta-data associated with the social-media content piece may involve storing a voice call history associated with the social-media content piece. Storing a voice call history associated with the social-media content piece may involve storing a time duration of each of the voice calls of the voice call history. Storing a voice call history associated with the social-media content piece may involve storing a time elapsed between successive ones of the voice calls of the voice call history. Storing a voice call history associated with the social-media content piece may involve storing a recording of at least a portion of one or more voice calls of the voice call history. Storing a recording of at least a portion of one or more voice calls of the voice call history may involve storing an audio recording. Storing a recording of at least a portion of one or more voice calls of the voice call history may involve storing a video recording. Storing a voice call history associated with the social-media content piece may involve storing notes associated with the voice calls of the voice call history and with associated call recipients, respectively. Storing a voice call history associated with the social-media content piece may involve storing indications of the identity of each person who terminated each of the voice calls of the voice call history.

Presenting, in response to a social-media content piece, at least one option for making a voice call having a call identification associated with the social-media content piece may involve presenting the at least one option for making the voice call having the call identification associated only with the social-media content piece and the meta-data. Presenting, in response to a social-media content piece, at least one option for making a voice call having a call identification associated with the social-media content piece may involve presenting the at least one option for making the voice call having the call identification stored in the database in association with only the social-media content piece and the meta-data.

Presenting, in response to a social-media content piece, at least one option for making a voice call having a call identification associated with the social-media content piece may involve posting a replying social-media content piece. Posting a replying social-media content piece may involve publishing the replying social-media content piece. Posting a replying social-media content piece may involve transmitting the replying social-media content piece via the Internet. Posting a replying social-media content piece may involve privately transmitting the replying social-media content piece. Posting a replying social-media content piece may involve posting the replying social-media content piece via the social networking service. Posting a replying social-media content piece may involve posting the replying social-media content piece via the second social networking service. Posting a replying social-media content piece may involve posting the replying social-media content piece via the plurality of social networking services. Posting the replying social-media content piece via the plurality of social networking services may involve posting the replying social-media content piece via the social networking service.

Presenting, in response to a social-media content piece, at least one option for making a voice call having a call identification associated with the social-media content piece may involve posting a replying social-media content piece containing the at least one option.

Presenting, in response to a social-media content piece, at least one option for making a voice call having a call identification associated with the social-media content piece may involve posting the replying social-media content piece containing a hyperlink. Posting the replying social-media content piece containing a hyperlink may involve posting the replying social-media content piece containing the hyperlink associated with the social-media content piece. Posting the replying social-media content piece containing a hyperlink may involve posting the replying social-media content piece containing the hyperlink associated only with the social-media content piece. Posting the replying social-media content piece containing a hyperlink may involve posting the replying social-media content piece containing the hyperlink associated only with the social-media content piece and the meta-data. Storing meta-data associated with the social-media content piece may involve storing the number of times the hyperlink has been invoked.

Presenting, in response to a social-media content piece, at least one option for making a voice call having a call identification associated with the social-media content piece may involve detecting invocation of the hyperlink. Detecting invocation of the hyperlink may involve detecting invocation, by an Internet-capable device, of the hyperlink.

Presenting, in response to a social-media content piece, at least one option for making a voice call having a call identification associated with the social-media content piece may involve determining whether authorization is required. Determining whether authorization is required may involve determining whether authorization of the source of the social-media content piece is required. Presenting, in response to a social-media content piece, at least one option for making a voice call having a call identification associated with the social-media content piece may involve prompting for social-media account credentials. Prompting for social-media account credentials may involve displaying a prompt at the Internet-capable device. Presenting, in response to a social-media content piece, at least one option for making a voice call having a call identification associated with the social-media content piece may involve determining whether credentials received as user input match corresponding identification information associated with the source of the social-media content piece. Determining whether social media credentials received as user input match corresponding identification information associated with the source of the social-media content piece may involve receiving the social media credentials in association with a user of the Internet-capable device. Receiving the social media credentials in association with a user of the Internet-capable device may involve receiving the social media credentials via one of the one or more social networking services. Determining whether social media credentials received as user input match corresponding identification information associated with the source of the social-media content piece may involve comparing the user identification associated with the social-media content piece with a second user identification of the social media credentials. Presenting, in response to a social-media content piece, at least one option for making a voice call having a call identification associated with the social-media content piece may involve obtaining an indication of whether the user identification associated with the social-media content piece matches a user identification associated with a social media account being used at the Internet-capable device at which the hyperlink was invoked. Obtaining an authentication indication of whether the user identification associated with the social-media content piece matches a user identification associated with a social media account being used at the Internet-capable device at which the hyperlink was invoked may involve requesting the authentication indication from a third-party authenticator. Requesting the authentication indication from a third-party authenticator may involve requesting the authentication indication from a social networking service. Requesting the authentication indication from a third-party authenticator may involve requesting the authentication indication from a social networking service associated with the social-media content piece. Requesting the authentication indication from a third-party authenticator may involve requesting the authentication indication from a social networking service associated with the social media account being used at the Internet-capable device at which the hyperlink was invoked. Requesting the authentication indication from a third-party authenticator may involve providing to the third-party authenticator the user identification associated with the social-media content piece.

Presenting, in response to a social-media content piece, at least one option for making a voice call having a call identification associated with the social-media content piece may involve displaying the at least one option. Presenting, in response to a social-media content piece, at least one option for making a voice call having a call identification associated with the social-media content piece may involve displaying the at least one technology option. Presenting, in response to a social-media content piece, at least one option for making a voice call having a call identification associated with the social-media content piece may involve displaying the at least one option at the Internet-capable device.

Presenting, in response to a social-media content piece, at least one option for making a voice call having a call identification associated with the social-media content piece may involve presenting a first option for making the voice call using a browser-based VoIP technology. Presenting a first option for making the voice call using a browser-based VoIP technology may involve presenting the first option for making a video call using the browser-based VoIP technology. Presenting, in response to a social-media content piece, at least one option for making a voice call having a call identification associated with the social-media content piece may involve presenting a second option for making the voice call using an application-based VoIP technology. Presenting a second option for making the voice call using an application-based VoIP technology may involve presenting the second option for making a video call using the application-based VoIP technology. Presenting, in response to a social-media content piece, at least one option for making a voice call having a call identification associated with the social-media content piece may involve presenting a third option for making the voice call using a PSTN technology. Presenting a third option for making the voice call using a PSTN technology may involve presenting the third option for making a video call using the PSTN technology.

Determining, in response to receiving a selection of the at least one option, the call identification may involve determining, in response to receiving the selection of the at least one technology option, the call identification. Determining, in response to receiving a selection of the at least one option, the call identification may involve determining the call identification by a system. Determining, in response to receiving a selection of the at least one option, the call identification may involve determining the call identification by a computer-implemented system. Determining, in response to receiving a selection of the at least one option, the call identification may involve determining the call identification by the computer-implemented system for performing the method.

Determining, in response to receiving a selection of the at least one option, the call identification may involve receiving the selection. Determining, in response to receiving a selection of the at least one option, the call identification may involve receiving the selection from the Internet-capable device. Determining, in response to receiving a selection of the at least one option, the call identification may involve receiving the selection having been transmitted by the Internet-capable device. Determining, in response to receiving a selection of the at least one option, the call identification may involve determining the call identification according to the selection. Determining, in response to receiving a selection of the at least one option, the call identification may involve determining a call identification value and assigning the call identification the value of the call identification value.

Determining, in response to receiving a selection of the at least one option, the call identification may involve determining whether the selection is the browser-based VoIP technology. Determining, in response to receiving a selection of the at least one option, the call identification may involve determining a browser-VoIP DID. Determining, in response to receiving a selection of the at least one option, the call identification may involve assigning the call identification the value of the browser-VoIP DID.

Determining, in response to receiving a selection of the at least one option, the call identification may involve determining whether the selection is the application-based VoIP technology. Determining, in response to receiving a selection of the at least one option, the call identification may involve determining an application-VoIP DID. Determining, in response to receiving a selection of the at least one option, the call identification may involve assigning the call identification the value of the application-VoIP DID.

Determining, in response to receiving a selection of the at least one option, the call identification may involve determining whether the selection is the PSTN technology. Determining, in response to receiving a selection of the at least one option, the call identification may involve determining a PSTN DID. Determining, in response to receiving a selection of the at least one option, the call identification may involve assigning the call identification the value of the PSTN DID.

Determining a PSTN DID may involve determining a location associated with the IP (Internet Protocol) address of the Internet-capable device. Determining a location associated with the IP address of the Internet-capable device may involve determining a country and at least one of a region within the country and a city within the country. Determining a PSTN DID may involve determining a telephonic area code associated with the location. Determining a PSTN DID may involve determining whether the pre-purchased local DID is available. Determining whether the pre-purchased local DID is available may involve determining whether the pre-purchased local DID is stored in a database. Determining whether the pre-purchased local DID is stored in a database may involve determining whether the pre-purchased local DID is stored in the database of the system. Determining a PSTN DID may involve determining whether a local DID is available for purchasing. Determining a PSTN DID may involve purchasing a local DID. Determining a PSTN DID may involve adding a purchased local DID to the database. Determining a PSTN DID may involve determining whether the toll-free DID is available. Determining whether the toll-free DID is available may involve determining whether the toll-free DID is stored in the database.

The method may involve displaying the call identification. Displaying the call identification may involve displaying the call identification at the Internet-capable device. Displaying the call identification may involve displaying the call identification when the selection is the PSTN technology. Displaying the call identification may involve displaying the pre-purchased local DID. Displaying the call identification may involve displaying the purchased local DID. Displaying the call identification may involve displaying the toll-free DID.

Forwarding the voice call to a call recipient may involve forwarding the voice call to the call recipient according to the selection. Forwarding the voice call to a call recipient may involve forwarding a video call to the call recipient.

Forwarding the voice call to a call recipient may involve receiving a call to a receiving DID. Receiving a call to a receiving DID may involve receiving the call to the receiving DID of the system. Receiving a call to a receiving DID may involve receiving the call by browser-based VoIP technology. Receiving a voice call to a receiving DID may involve receiving the call by application-based VoIP technology. Receiving a voice call to a receiving DID may involve receiving the call by PSTN technology.

Forwarding the voice call to a call recipient may involve determining a caller ID associated with the call. Forwarding the voice call to a call recipient may involve storing the caller ID in the database. Forwarding the voice call to a call recipient may involve storing the caller ID as meta data in association with the social-media content piece.

Forwarding the voice call to a call recipient may involve determining whether the receiving DID is assigned to a call identification. Forwarding the voice call to a call recipient may involve determining whether the receiving DID has been previously called. Forwarding the voice call to a call recipient may involve determining whether the receiving DID has been previously called in association with the caller ID. Forwarding the voice call to a call recipient may involve determining whether the receiving DID has been previously called from a communications device associated with the caller ID. Forwarding the voice call to a call recipient may involve demoting the receiving DID. Demoting the receiving DID may involve moving the receiving DID to a lower ranked position within an ordered list of receiving DIDs within the database. Demoting the receiving DID may involve making the receiving DID less likely to be selected for being assigned to a subsequent call identification. Demoting the receiving DID may involve preventing the receiving DID from being assigned to the subsequent call identification until a restoration condition is met. Preventing the receiving DID from being assigned to the subsequent call identification until a restoration condition is met may involve permitting the receiving DID to be assigned to the subsequent call identification after the elapse of a specifiable time during which no calls to the receiving DID are received. Forwarding the voice call to a call recipient may involve playing an error message associated with an unassigned receiving DID. Forwarding the voice call to a call recipient may involve disconnecting the call.

Forwarding the voice call to a call recipient may involve determining whether the call identification is expired. Determining whether the call identification is expired may involve determining whether an expiration limit associated with the call identification is exceeded. Determining whether the call identification is expired may involve determining whether the number of times the hyperlink has been invoked exceeds a pre-determined hyperlink invocation limit. Determining whether the call identification is expired may involve determining whether a call count of the number of times the call identification has been used for a completed call exceeds a pre-determined call count limit. Determining whether the call identification is expired may involve determining whether a call count of the number of voice calls associated with the call identification that have been completed exceeds the pre-determined call count limit. Determining whether the call identification is expired may involve determining whether the time elapsed since a most recent previous voice call associated with the call identification exceeds a pre-determined previous-call time limit. Determining whether the call identification is expired may involve determining whether the time elapsed between a most recent previous invocation of the hyperlink and the voice call exceeds a pre-determined hyperlink-to-call time limit. Determining whether the call identification is expired may involve determining whether the total duration of time spent during all voice calls previously made in association with the call identification exceeds a pre-determined total call time limit. Determining whether the call identification is expired may involve determining whether the duration of the most recent previous voice call associated with the call identification exceeds a pre-determined maximum call time limit. Determining whether the call identification is expired may involve determining whether the sum of the durations of all previous voice calls associated with the call identification exceeds the pre-determined maximum call time limit. Determining whether the call identification is expired may involve determining whether a command to expire the call identification has been received.

Forwarding the voice call to a call recipient may involve playing an error message associated with an expired call identification. Forwarding the voice call to a call recipient may involve disconnecting the voice call.

Forwarding the voice call to a call recipient may involve selecting the call recipient. Forwarding the voice call to a call recipient may involve selecting the call recipient according to the voice call history.

Forwarding the voice call to a call recipient may involve determining the private DID of the call recipient. Forwarding the voice call to a call recipient may involve retrieving the meta-data. Forwarding the voice call to a call recipient may involve incrementing the call count associated with the call identification. Forwarding the voice call to a call recipient may involve starting a timer associated with the call identification. Forwarding the voice call to a call recipient may involve starting a timer for timing the duration of the voice call. Forwarding the voice call to a call recipient may involve connecting the voice call. Forwarding the voice call to a call recipient may involve connecting the voice call between the communications device and the call recipient. Connecting the voice call between the communications device and the call recipient may involve connecting a video call between the communications device and the call recipient.

Forwarding the voice call to a call recipient may involve delivering the meta-data to the call recipient. Forwarding the voice call to a call recipient may involve delivering the meta-data to an auxiliary device associated with the call recipient. Delivering the meta-data to the call recipient may involve transmitting a text message. Delivering the meta-data to the call recipient may involve transmitting an email message. Delivering the meta-data to the call recipient may involve executing a streaming API. Delivering the meta-data to the call recipient may involve performing a text-to-speech conversion. Delivering the meta-data to the call recipient may involve performing speech synthesis. Delivering the meta-data to the call recipient may involve executing a text-to-speech API.

In accordance with another aspect of the invention, there is provided a system for managing voice calls in association with social media content. The system includes: (a) a first system component for presenting, in response to a social-media content piece, at least one option for making a voice call having a call identification associated with the social-media content piece; (b) a second system component for determining, in response to receiving a selection of the at least one option, the call identification; and (c) a third system component for forwarding the voice call to a call recipient.

The system includes a processor and a memory in communication therewith. The system may include a database in communication with the processor.

Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a block diagram of a telecommunications environment within which operates a system for managing voice calls in association with social media content according to a first embodiment of the invention;

FIG. 2 is a screen shot of a main screen of the system of FIG. 1, showing a plurality of social-media content pieces;

FIG. 3 is a screen shot of the main screen shown in FIG. 2, showing a reply menu;

FIG. 4 is a screen shot of the main screen shown in FIG. 2, showing a compose-reply dialog box;

FIG. 5 is a screen shot of the main screen shown in FIG. 2, showing a replying social-media content piece and its status;

FIG. 6 is a screen shot of an authorization web page displayed by the system of FIG. 1, showing a request for authorization to verify social-media account credentials;

FIG. 7 is a screen shot of an authorization-failed web page displayed by the system of FIG. 1, showing an error message indicating that authorization has failed;

FIG. 8 is a screen shot of an option-selection web page displayed by the system of FIG. 1, showing buttons for selecting a technology option for making a voice call;

FIG. 9 is a screen shot of a portion of the option-selection web page shown in FIG. 8, showing a telephone number;

FIG. 10 is a screen shot of a portion of the main screen shown in FIG. 2, showing an icon for selecting administrative settings associated with the system of FIG. 1;

FIG. 11 is a screen shot of the portion shown in FIG. 10, showing a phone number setting and a dialog box for creating a reply template;

FIG. 12 is a screen shot of the portion shown in FIG. 10, showing a menu for sorting replies according to their respective statuses;

FIG. 13 is a flow diagram of a method of managing voice calls in association with social media content according to the first embodiment of the invention;

FIG. 14 is a flow diagram showing steps of the method of FIG. 13 for presenting, in response to the social-media content piece, at least one technology option for making a voice call having a call identification associated with the social-media content piece;

FIG. 15 is a flow diagram showing steps of the method of FIG. 14 for posting a replying social-media content piece containing a hyperlink that is associated with the social-media content piece;

FIG. 16 is a flow diagram showing a first part of steps of the method of FIG. 13 for determining, in response to receiving a selection of the at least one technology option, the call identification;

FIG. 17 is a flow diagram showing a second part of the steps of the method of FIG. 13 for determining, in response to receiving a selection of the at least one technology option, the call identification;

FIG. 18 is a flow diagram showing a first part of steps of the method of FIG. 13 for forwarding the voice call to a call recipient; and

FIG. 19 is a flow diagram showing a second part of the steps of the method of FIG. 13 for forwarding the voice call to a call recipient.

### DETAILED DESCRIPTION

A system for managing voice calls in association with social media content includes: (a) means for presenting, in response to a social-media content piece, at least one option for making a voice call having a call identification associated with the social-media content piece; (b) means for determining, in response to receiving a selection of the at least one option, the call identification; and (c) means for forwarding the voice call to a call recipient.

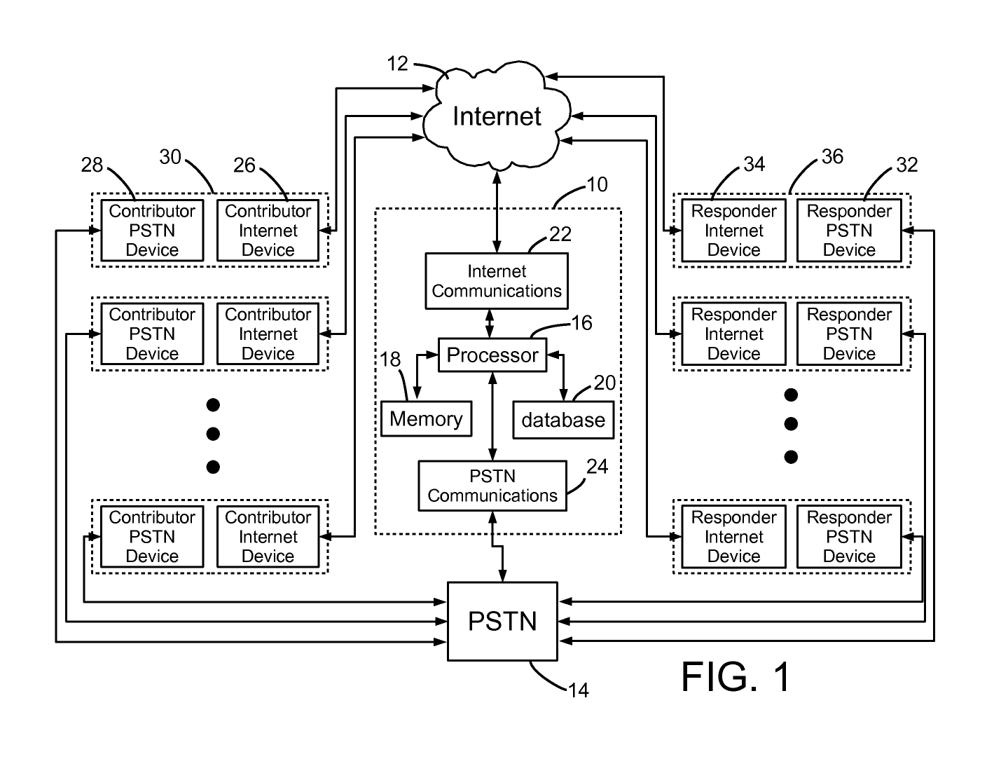

Referring to FIG. 1, the system according to a first embodiment of the invention is shown generally at 10. The system 10 operates in a telecommunications and computing environment having a global computer network system, such as the Internet 12 shown in FIG. 1, and a circuit-switched telephone networks system, such as the Public Switched Telephone Network (PSTN) 14 shown in FIG. 1.

The system 10 includes a processing circuit, such as the processor 16 shown in FIG. 1. The processor 16 may be of any suitable type, may be or include a central processing unit (CPU), and may be implemented by any number of processing circuits, including parallel and/or redundant processing circuits, for example. In the first embodiment, the processor 16 includes, or is in communication with, a memory circuit such as the memory 18, which is shown in FIG. 1 as being in communication with the processor 16. The memory 18 in the first embodiment is operable to store digital representations of data or other information, including program code for directing operations of the processor 14. The memory 18 may be implemented in any suitable manner by any number of memory circuits, for example.

In the first embodiment, the system 10 includes a database 20. The database 20 may be implemented as part of the processor 16 and/or the memory 18, or may be implemented separately from both the processor 16 and the memory 18 as shown in FIG. 1. The database 20 typically functions to store information, typically in the form of recordable and retrievable data for use within or by the system 10, including data records stored in association with other data records. While FIG. 1 shows one database 20 in communication with the processor 16, the system 10 may in general include any number of databases 20, including having different databases 20 configured for storing information associated with different categories of information and/or having different databases 20 configured for storing different data associated with different data types, for example. In some embodiments, all data and other information stored by the system 10 is stored in the memory 18 such that the system 10 does not include the database 20.

In the first embodiment, the system 10 includes an Internet communications module 22 for facilitating communications of the system 10 via the Internet 12; and a PSTN communications module 24 for facilitating communications of the system 10 via the PSTN 14. While FIG. 1 shows the system 10, each contributor Internet device 26 and each responder Internet device 34 being in communication with each other via the Internet 12, in some embodiments one or more contributor Internet devices 26, one or more responder Internet devices 34, or both one or more contributor Internet devices 26 and one or more responder Internet devices 34, may be in direct communication with the system 10. In some embodiments, one or more contributor PSTN devices 28, one or more responder PSTN devices 36, or both one or more contributor PSTN devices 28 and one or more responder PSTN devices 36, are in direct communication with the system 10, in addition or alternatively to being in communication with the PSTN 14, so as to permit PSTN 14 communications via the system 10.

In some embodiments, the system 10 is implemented as a single apparatus containing the processor 16, memory 18, Internet communications module 22, PSTN communications module 24. Such apparatus may also include the database 20. Additionally or alternatively, the system 10 may be implemented by any number of inter-communicating system 10 modules disposed at any number of geographical locations, for example.

The telecommunications and computing environment in which the system 10 operates includes any number of communications devices, including contributor Internet devices 26 of individuals who contribute social media content for publication or private transmission via the Internet 12. The social media content may be any Internet-accessible data or information to which another individual, entity or automated system can reply in a manner that is also accessible by the Internet 12. For example, the social media content may be any content of a posting, message, tweet, blog entry, web page, transmission, document, other information package, or any combination thereof. The social media content is typically published or privately transmitted via a social networking service, including any similar or related information service that facilitates replying to form a thread of communications or other information.

Such contributing individuals may also operate a contributor PSTN device 28 operable to connect to the PSTN 14, which may be a telephone for example. In the telecommunications and computing environment shown in FIG. 1, the contributor Internet device 26 and the contributor PSTN device 28 of each contributor forms one contributor communication set 30. In general, however, each contributor communication set 30 may include any number of devices for accessing the Internet 12 alone or accessing the Internet 12 and connecting to the PSTN 14, including a single device such as a web-enabled telephone, which may be a mobile phone, operable to connect to both the Internet 12 and the PSTN 14.

After a contributor has published or privately transmitted social media content, other individuals may respond to the social media content by contributing replying social-media content. Such responses may be effected by responder Internet devices 32 connected to the Internet as shown in FIG. 1. Each responding individual may also operate a responder PSTN device 34 operable to connect to the PSTN 14, which may be a telephone for example. The responder Internet device 32 and the responder PSTN device 34 of each responding individual is shown in FIG. 1 as a responder communication set 36, which in general may include any number of devices for accessing the Internet 12 alone or accessing the Internet 12 and connecting to the PSTN 14 and may include a single device operable to connect to both the Internet 12 and the PSTN 14. Typically, any given individual may be either or both a contributor and a responder.

Communications between the various devices shown in FIG. 1 and communications of the system 10, Internet 12 and PSTN 14 may be effected by wired or wireless connection, including a copper wire link, a coaxial cable link, a fiber-optic transmission link, a radio link, a cellular telephone link, a satellite link, a line-of-sight link, and any combination thereof, for example. Such communications can include the transmission of social-media content, replies to social-media content, and voice calls, for example. The voice calls may be effected by any suitable technology, including analog and/or digital telephony, Voice-over-Internet Protocol (VoIP) technology, or other related technologies. The voice calls of any technology may be video calls, for example, in which not only audio information, but also video or other image-like information, is also transmitted, including possibly transmitting audio and video information simultaneously.

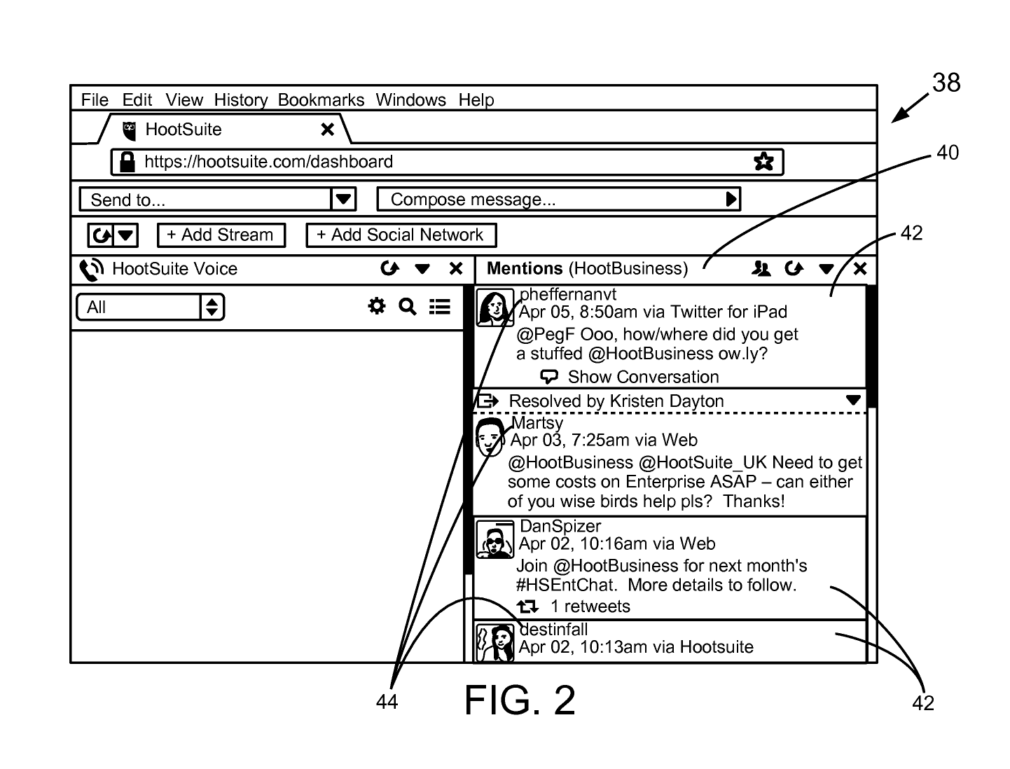

Referring to FIG. 2, the system 10 (FIG. 1) is operable to present to a system 10 user a main screen 38 in accordance with the first embodiment of the invention. In the first embodiment, the main screen 38 is presented as an Internet-accessible web page of a Software-as-a-Service (SaaS) platform in accordance with cloud computing capabilities of the system 10. In some embodiments the system 10 is implemented using a stand-alone application installed in a user computing device. In some embodiments, the system 10 employs a combination of installed components and Internet-accessible components. In the first embodiment, the main screen 38 provides a user interface to voice calling features of the system 10. The system 10 may be implemented as an improved HootSuite™ social media management system offered by HootSuite Media Inc. of Vancouver, British Columbia, Canada.

As shown in FIG. 2, a mentions column 40 lists a number of social-media content pieces 42. Typically, each social-media content piece meets specifiable criteria for being included in the mentions column 40, such as including reference to a particular business, product, marketing campaign, definable topic or concept, other criteria, or any combination thereof for example. Typically, each social-media content piece is retrieved from a public or private posting of social media content made via a social networking service through monitoring and filtering of social media content accessible from the Internet 12 to the system 10. Each social-media content piece shown in FIG. 2 includes a social media handle 44 identifying a source account of the social-media content piece.

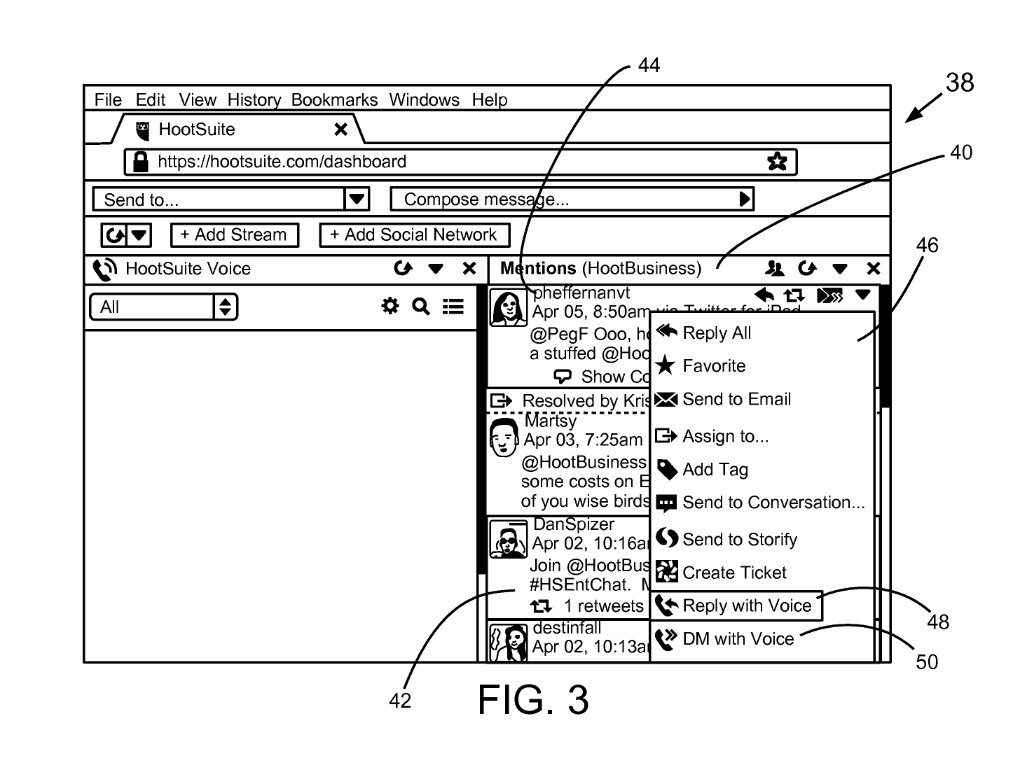

Referring to FIG. 3, social networking services typically permit the posting of social media content replies to previously published or privately transmitted social media content. As shown in FIG. 3, a reply menu 46 presented by the system 10 includes a reply-with-voice menu selection 48 and a DM-with-voice menu selection 50, each of which permit a system 10 user to create replying social-media content containing an invitation to make a voice call. As described further herein below, the reply-with-voice menu selection 48 is associated with a requirement for authorization, while the DM-with-voice menu selection 50 is associated with no requirement for authorization. While the exemplary DM-with-voice menu selection 50 references “DM” as an abbreviation for direct message, a known term in use by a specific social networking service, the system 10 in various embodiments is operable in relation to any number of different social networking services. In the example shown in FIG. 3, the reply menu 46 is invoked in relation to the particular social-media content piece 42 which is associated with the social media handle 44 having the displayed value of “pheffernanvt”.

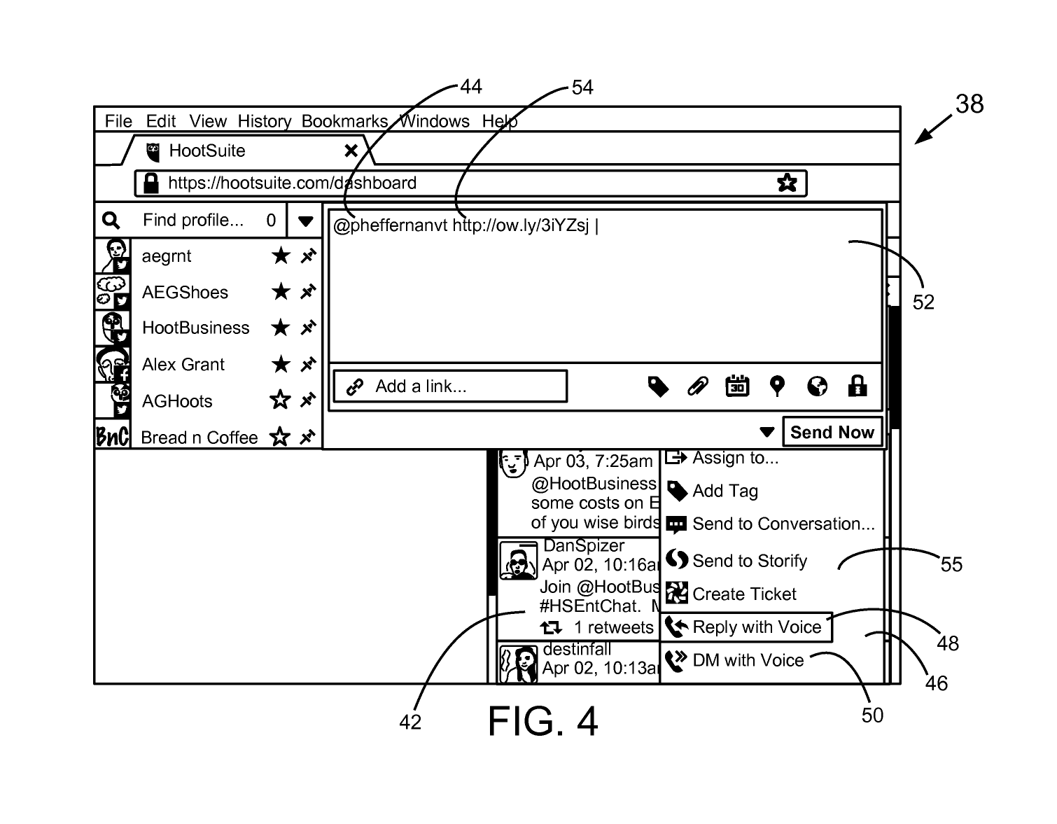

Referring to FIG. 4, a compose-reply dialog box 52 provides white space for composing a reply to the social-media content piece 42 to which the compose-reply dialog box 52 relates. The exemplary reply of FIG. 4 is addressed to the social media handle 44 “@pheffernanvt” of the particular social-media content piece 42 to which the compose-reply dialog box 52 relates. The compose-reply dialog box 52 of FIG. 4 also includes a hyperlink 54 having the exemplary value of “http://ow.ly/3iYZsi”. Further social media content may be composed within the compose-reply dialog box 52, including text (e.g. “Click on the link http://ow.ly/3iYZsi for a voice call to our customer service representative.”), other hyperlinks, icons, graphics, multi-media presentations, etc., as may be suitable within any constraints of the system 10, Internet 12, and/or a selected social networking service for example. FIG. 4 shows a send button 55 for issuing a send command after the system 10 user is satisfied with the contents of the compose-reply dialog box 52. In the first embodiment, the system 10 is operable to receive the send command that was issued by invoking the send button 55, and in response thereto send the contents of the compose-reply dialog box 52.

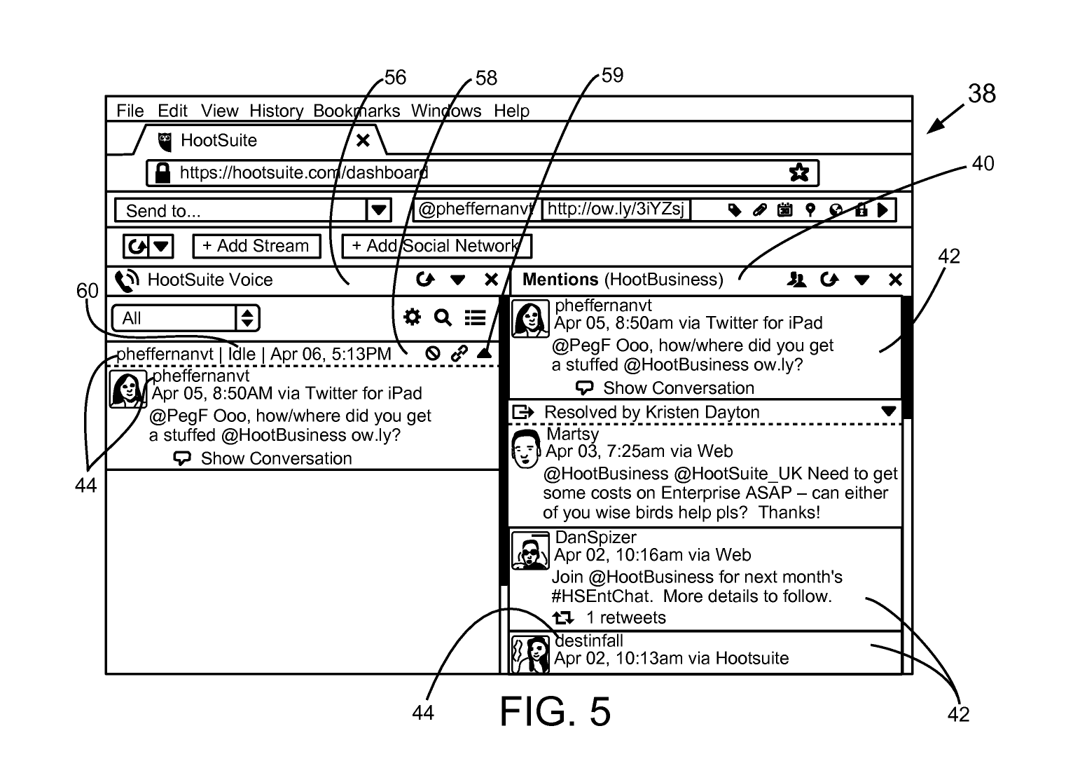

FIG. 5 shows a voice column 56 for displaying replying social-media content pieces 58 in association with social-media content pieces 42. The exemplary replying social-media content piece 58 shown in FIG. 5 is associated with the exemplary social-media content piece 42 that is associated with the exemplary social media handle 44 “pheffernanvt”. In the first embodiment, the system 10 is operable to create the replying social-media content piece 58 as the contents of the compose-reply dialog box 52 (FIG. 4) at the time the send command was received by the system 10. In the first embodiment, the system 10 is operable to display or not display the associated social-media content piece 42 in the voice column 56 in accordance with a expand/contract display button 59 shown in FIG. 5.

FIG. 5 also shows an exemplary status indication 60 of “Idle” associated with the exemplary replying social-media content piece 58 shown in FIG. 5. As shown in FIG. 5, the status of “Idle” indicates that the replying social-media content piece 58 has been sent containing the hyperlink 54 which has not yet invoked. Other status indications 60 (not shown in FIG. 5) are possible, such as to provide indications whether the hyperlink 54 has been invoked, whether a voice call is in progress, whether a voice call is completed, and whether a hyperlink 54 is expired, for example.

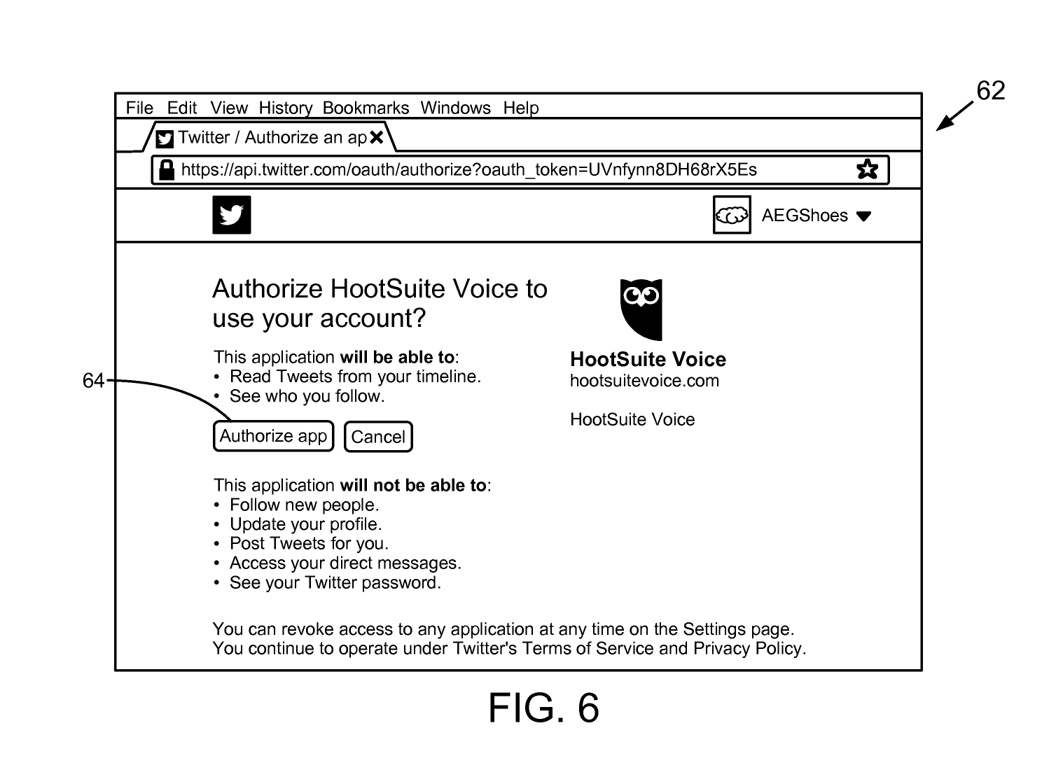

FIG. 6 shows an authorization web page 62 presented by the system 10 at the contributor Internet device 26 associated with a given social media handle 44 (FIGS. 2 to 5). Typically, any particular contributor Internet device 26 is temporarily associated with the given social media handle 44 during the time in which the contributor is logged into a social networking service at the contributor Internet device 26 and able to view the hyperlink 54, for example. The authorization web page 62 prompts for authorization to obtain social media credentials such as the social media handle 44 associated with the social networking service account being used to view the authorization web page 62. If the “Authorize app” button 64 is selected, the system 10 in the first embodiment is operable to obtain the social media credentials of the social media account used to select the button 64 for comparison with the social media handle 44 addressed by the replying social-media content piece 58, thereby advantageously verifying whether the social media account being used to attempt a voice call is the specific social media account that was intended by the system 10 user who created the replying social-media content piece. In the first embodiment, the system 10 is operable to obtain the social media credentials from a social networking service, such as the social networking service providing the social media account being used to attempt the voice call. In some embodiments, the system 10 is operable to obtain an authentication indication from the social networking service, or other third-party authenticator, as to whether the social media account being used to attempt the voice call is the specifically intended social media account. For example, the system 10 may be operable to request authentication from the third-party authenticator and to receive therefrom a response indicating whether the authentication attempt succeeded or failed. In making the request, the system 10 may need to provide the third-party authenticator with the social media handle 44 addressed by the replying social-media content piece 58, for example.

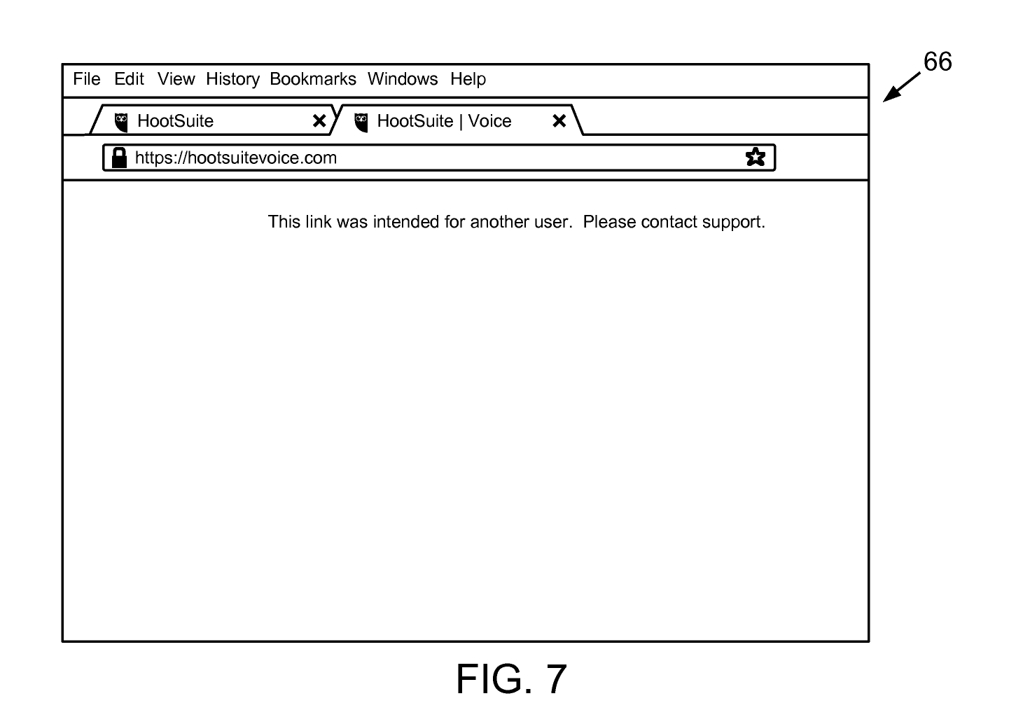

FIG. 7 shows an authorization-failed web page 66 being displayed by the system 10 at an Internet-capable device (not shown) upon the system 10 determining that the social media credentials of the social networking account used to authorize verification or authentication at a given authorization web page 62 does not match the social media handle 44 addressed by the replying social-media content piece 58 that contained the hyperlink 54 invoked to display the given authorization web page 62. In the first embodiment, the text or other content of the authorization-failed web page 66 is predetermined and customizable by administrative settings of the system 10.

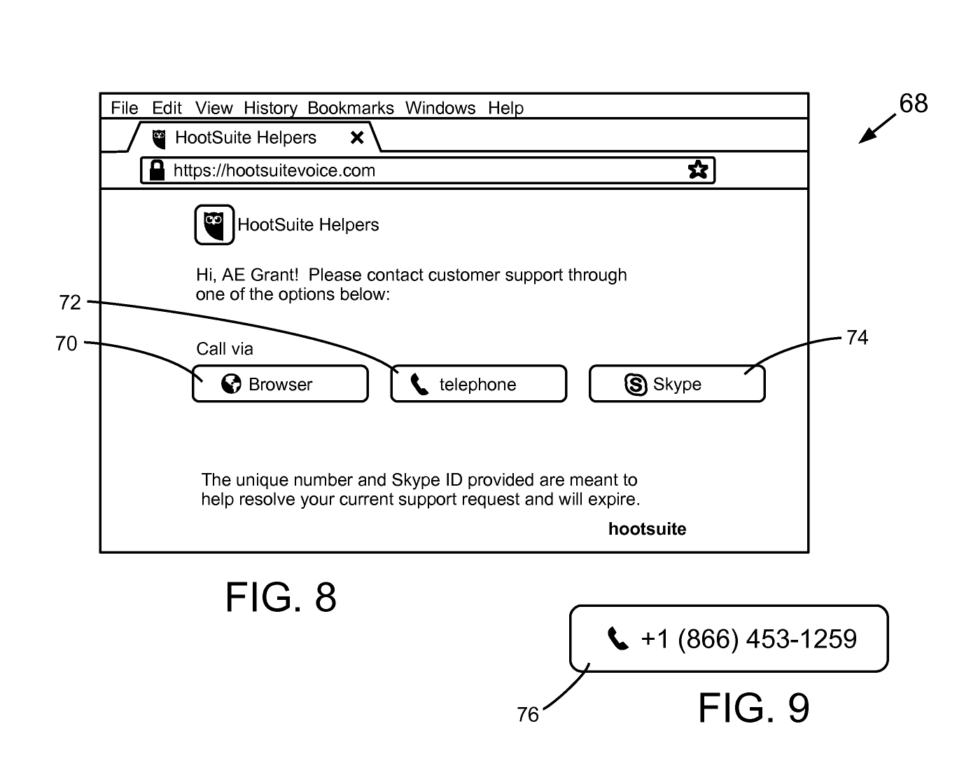

FIG. 8 shows an option-selection web page 68 for presenting at least one option for making a voice call. The system 10 is operable to display the option-selection web page 68 at the contributor Internet device 26 upon successful authorized verification or authentication of social media credentials. While the authorization web page 62 of FIG. 6 in the first embodiment is the landing web page after selecting the hyperlink 54 (FIG. 4) when authorization to verify or authenticate social media credentials is required by the system 10, the option-selection web page 68 of FIG. 8 is the landing web page after selecting the hyperlink 54 when verification or authentication occurs automatically without explicit authorization or, more typically, when both verification and authentication are not required by the system 10.

The exemplary option-selection web page 68 shown in FIG. 8 includes the browser-VoIP selection button 70, telephone selection button 72 and the Skype™ VoIP selection button 74. While FIG. 8 shows the three exemplary technology options of browser-VoIP technology, PSTN technology and application-VoIP technology for making a voice call, in general any number of technology options may be included in the option-selection web page 68. While the option-selection web page 68 of FIG. 8 includes one option related to a stand-alone application for making a VoIP call, namely the Skype™ VoIP selection button 74, any number of stand-alone applications and any number of voice calling technologies may be supported by the system 10 for example.

In the first embodiment, the system 10 is operable to initiate a browser-based VoIP session between the contributor Internet device 26 and the system 10 upon selection at the contributor Internet device 26 of the browser-VoIP selection button 70. Typically, the system 10 requires that an appropriate browser plug-in be installed at the contributor Internet device 26, or that the contributor Internet device 26 otherwise be operable to provide browser-based VoIP services, in order to complete the browser-based VoIP session. Also, the system 10 in the first embodiment is operable to initiate a Skype™ VoIP session between the contributor Internet device 26 and the system 10 upon selection at the contributor Internet device 26 of the Skype™ VoIP selection button 74. Typically, the system 10 requires that the Skype™ VoIP application be installed at the contributor Internet device 26 to complete the Skype™ VoIP session.

Referring to FIG. 9, selection of the telephone selection button 72 at the contributor Internet device 26 results in a display at the contributor Internet device 26 of a telephone number 76 for making a voice call as determined by the system 10 in accordance with embodiments of the invention. FIG. 9 shows a portion of the option-selection web page 68 in which the telephone selection button 72 is given the appearance of having been modified, upon selection thereof, to display the telephone number 76. It should be noted that, upon viewing the telephone number 76, a person can choose to dial the telephone number using a fixed-line telephone connected to the PSTN 14 (FIG. 1), a mobile phone connected to the PSTN 14, or a VoIP phone employing the person's chosen VoIP technology for example.

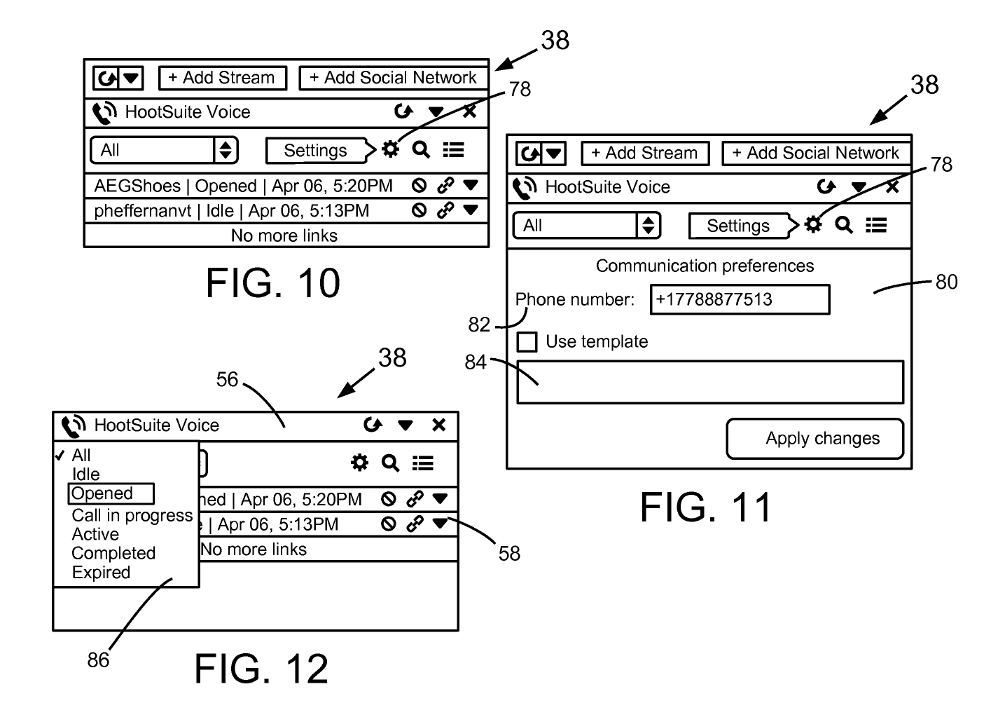

Referring to FIG. 10, the main screen 38 includes a settings icon 78 for invoking a settings user interface of the system 10 associated with administrative or other settings of the voice calling features of the system 10. While the exemplary settings icon 78 shown in FIG. 9 is the image of a mechanical gear, any suitable icon, text or other soft button may be employed.

FIG. 11 shows a settings window 80 displayed by the system 10 upon selection of the settings icon 78. Typically, the settings window 80 is displayed as a subset of the main screen 38. In the first embodiment, the settings window 80 occupies an area within the main screen 38 alternatively coinciding with the voice column 56 content area so as to advantageously provide the appearance of the voice column 56 and its associated settings window 80 being flip sides of each other.

As shown in FIG. 11, the settings window 80 includes a setting for a system 10 user to specify a direct telephone number 82 at which that system 10 user can be reached via any voice calling technology. For example, the direct telephone number 82 may be the work phone number of a system 10 user, including possibly being a mobile phone number for example.

In typical use of the system 10, the telephone number 76 (FIG. 9) is not the same as any of the system 10 users' direct telephone numbers 82. In the first embodiment, the system 10 is operable to forward a voice call using the telephone number 76 to a selected direct telephone number 82 without revealing the selected direct telephone number 82 to the person using the telephone number 76, thereby advantageously avoiding public disclosure of the direct telephone number 82.

In a variation, the system 10 is operable in some embodiments to receive as user input via the settings window 80 a direct VoIP number 82, VoIP username, or other VoIP user identification and to forward voice calls to such identified VoIP accounts.

The settings window 80 shown in FIG. 11 includes a template dialog box 84 for composing a reply template of the replying social-media content piece 58 (FIG. 4). In the first embodiment, the system 10 is operable to insert the contents of the template dialog box 84, if selected for use, into each replying social-media content piece 58 generated by the system 10 user.

While not shown in FIG. 11, other settings for use with the voice calling features of the system 10 can be set using the settings window 80 or other user interface features of the system 10. By way of example, rules for the expiration of a hyperlink 58, and rules for the expiration of the telephone number 76 and the corresponding VoIP DID (Direct Inward Dialing) or other VoIP destination address relating to each of the browser-VoIP and application-VoIP technologies may be specified.

In the first embodiment, different system 10 users can have different settings. Additionally or alternatively, organizational or team level administrative settings can be made common to a specifiable group of system 10 users.

Referring to FIG. 12, various replying social-media content pieces 58 may be selected for display within the voice column 56 by using a voice-call history filter menu 86. The system 10 in the first embodiment is operable to receive a selection among criteria for determining which replying social-media content pieces 58 to display in the voice column 56, and is operable to display the replying social-media content pieces 58 in accordance with the selection.

The voice call history display menu 86 shown in FIG. 12 includes:

the filtering criterion of “All” for displaying all replying social-media content pieces 58 stored by the system 10 in association with the system 10 user, including possibly in association with a group of system 10 users to which the system 10 user belongs;

the filtering criterion of “Idle” for displaying only each idle replying social-media content piece 58 which has been sent containing the hyperlink 54 which has not yet been invoked;

the filtering criterion of “Opened” for displaying only each opened replying social-media content piece 58 which have been sent containing the hyperlink 58 which has been invoked without an associated voice call being yet initiated;

the filtering criterion of “Call in progress” for displaying only each replying social-media content piece 58 associated with a currently occurring voice call;

the filtering criterion of “Active” for displaying only each replying social-media content piece 58 having the status of “Opened” or “Call in progress”;

the filtering criterion of “Completed” for displaying only each replying social-media content piece 58 for which an associated voice call has occurred and is completed; and

the filtering criterion of “Expired” for displaying only each replying social-media content piece 58 containing an expired hyperlink 54 and/or being associated with a telephone number 76 and corresponding VoIP DID which have expired.

Other filtering criterion are possible. While not shown in FIG. 12, the system 10 in some embodiments is operable to display the filtered replying social-media content pieces 58 in a selectable order, such as chronological, alphabetical, by status, etc., for example.

Thus, there is provided a system for managing voice calls in association with social media content, the system comprising: (a) a first system component for presenting, in response to a social-media content piece, at least one option for making a voice call having a call identification associated with said social-media content piece; (b) a second system component for determining, in response to receiving a selection of said at least one option, said call identification; and (c) a third system component for forwarding said voice call to a call recipient.

### Method of Operation

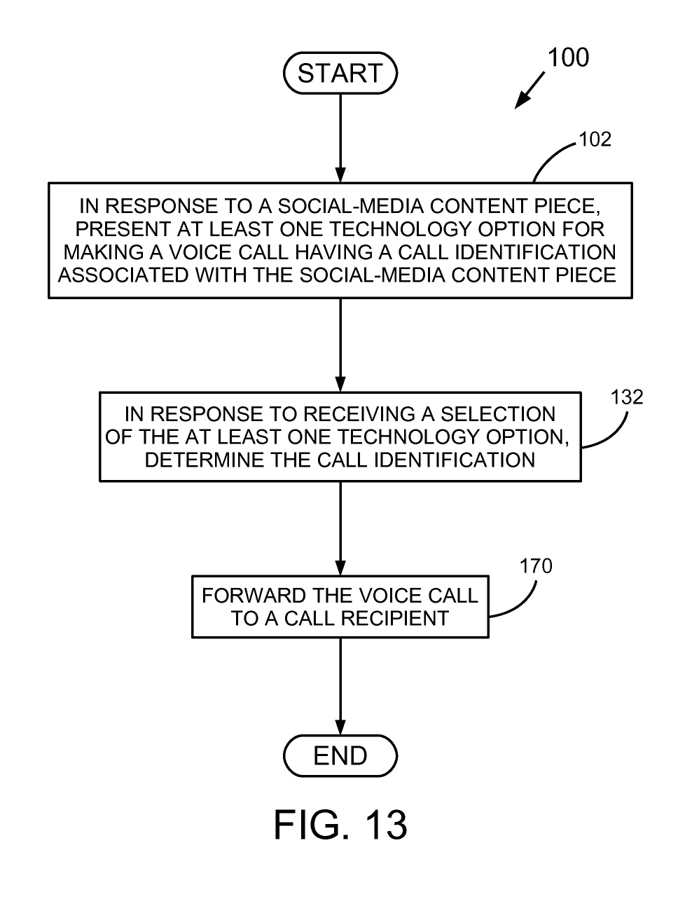

Referring to FIG. 13, the memory 18 (FIG. 1) in accordance with the first embodiment of the invention contains blocks of code comprising computer executable instructions for directing the processor 16 (FIG. 1) to perform the steps of a method shown generally at 100. Additionally or alternatively, such blocks of code may form part of a computer program product comprising computer executable instructions embodied in a signal bearing medium, which may be a recordable computer readable medium or a signal transmission type medium, for example.

When electrical power is being supplied to the processor 16 and the memory circuit 18, the processor 16 is directed to begin executing the instructions of block 102. Block 102 then directs the processor 14 to present, in response to a social-media content piece 42 (FIGS. 2-5), at least one technology option for making a voice call having a call identification associated with the social-media content piece 42. In the first embodiment, the call identification may be an associated telephone number 76 and/or an associated corresponding VoIP DID for example.

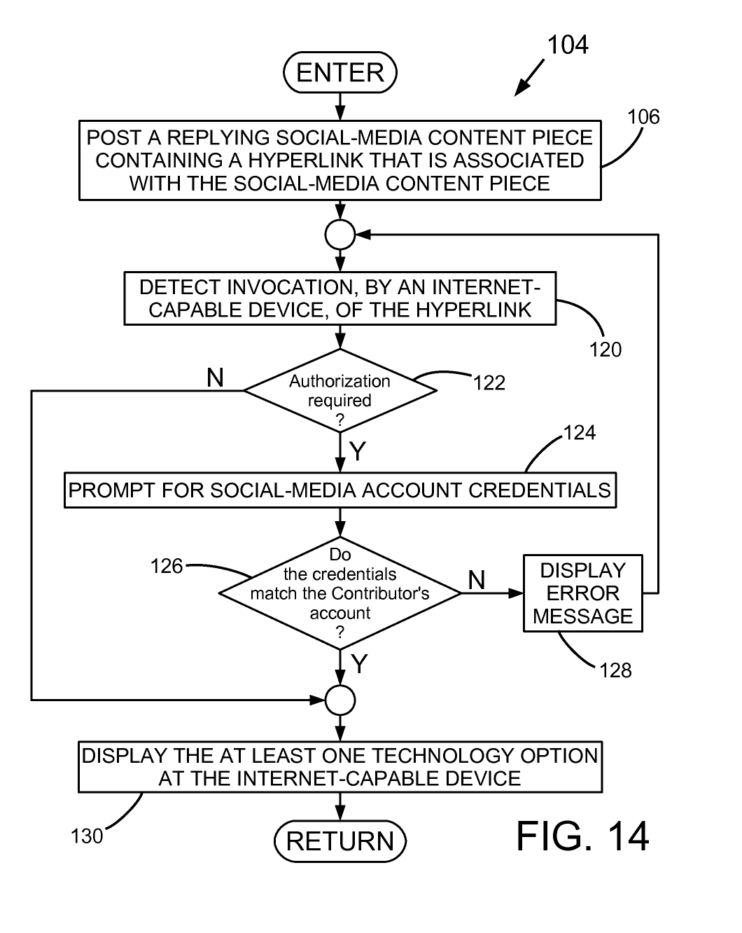

Referring to FIG. 14, an exemplary method for directing the processor 16 to perform steps of block 102 (FIG. 13) is shown generally at 104. The method 104 begins execution at block 106, which directs the processor 16 to post a replying social-media content piece 58 (FIG. 5) containing a hyperlink, such as the hyperlink 54 (FIG. 4), that is associated with the social-media content piece 42.

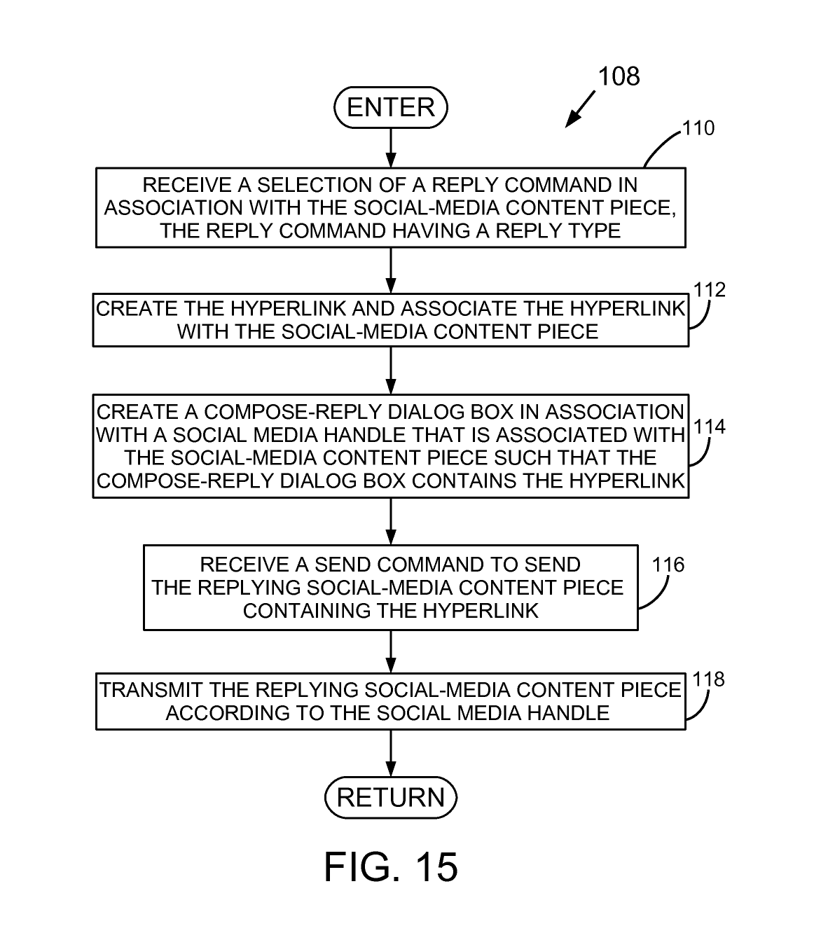

Referring to FIG. 15, an exemplary method for directing the processor 16 to perform steps of block 106 (FIG. 14) is shown generally at 108.

In the method 108, block 110 directs the processor 16 to receive the selection of a reply command in association with the social-media content piece 42, the reply command having associated therewith a reply type. In a typical example, receiving the selection of a reply command typically involves the system 10 receiving the selection from a given responder Internet device 34 (FIG. 1) when a system 10 user employs the given responder Internet device 34 to select either the reply-with-voice menu selection 48 (FIG. 3) or the DM-with-voice menu selection 50 (FIG. 3) in association with a given social-media content piece 42. In the first embodiment, the system 10 is operable to assign the reply type a value indicating whether the reply-with-voice menu selection 48 or the DM-with-voice menu selection 50 was selected. In the first embodiment, the processor 16 is operable to store the association between the reply command and the given social-media content piece 42 in the database 20 (FIG. 1).

While block 110 of the first embodiment directs the processor 16 to receive the selection of the reply command from the system 10 user, in some embodiments the steps of block 106 (FIG. 14) may be more automated such that posting a replying social-media content piece 58 containing the hyperlink 54 that is associated with the social-media content piece 42 involves automatedly determining whether to generate a reply to the social-media content piece 42. Automatedly determining whether to generate a reply to the social-media content piece 42 may involve linguistic or other computational analysis of the social-media content piece 42 to determine whether the social-media content piece 42 references or otherwise is related to an issue or topic for which a voice call may be helpful, for example. Automatedly determining whether to generate a reply to the social-media content piece 42 may also involve determining the reply type or otherwise automatedly determining whether to present the authorization web page 62 (FIG. 6) as described further herein.

After block 110 has been executed, block 112 then directs the processor 16 to create the hyperlink 54 and to associate the hyperlink 54 with the given social-media content piece 42. Creating the hyperlink 54 may involve any suitable automated process for generating a hyperlink or similar other link to a web page of the system 10, and in the first embodiment associating the hyperlink 54 with the given social-media content piece 42 involves storing the association between the hyperlink 54 and the given social-media content piece 42 in the database 20.

Block 114 then directs the processor 16 to create the compose-reply dialog box 52 (FIG. 4) in association with the social media handle 44 (FIG. 2) that is associated with the given social-media content piece 42 such that the compose-reply dialog box 52 contains the hyperlink 54. In the first embodiment, the system 10 is operable to insert the social media handle 44 into the contents of the compose-reply dialog box 52 as shown in FIG. 4. In some embodiments, the system 10 is operable to insert the social media handle 44 into an address box associated with the compose-reply dialog box 52, such as where email technology is being employed for example, or otherwise associate the replying social-media content piece 58 being created by use of the compose-reply dialog box 52 with a destination address. In some embodiments, creating the compose-reply dialog box 52 in association with the social media handle 44 that is associated with the social-media content piece 42 such that the compose-reply dialog box 52 contains the hyperlink 54 involves creating the compose-reply dialog box 52 in association with a plurality of social media handles 44 that are associated with a plurality of social networking services, respectively. Additionally or alternatively, any given social media handle 44 may be associated with a plurality of social networking services. In some embodiments, each social-media content piece 42 can be associated with one or more social media handles 44 such that creating the compose-reply dialog box 52 in association with the social media handle 44 that is associated with the social-media content piece 42 such that the compose-reply dialog box 52 contains the hyperlink 54 involves creating the compose-reply dialog box 52 in association with a plurality of social media handles 44 that are associated with the social-media content piece 42.

In the first embodiment, creating the compose-reply dialog box 52 involves inserting into the compose-reply dialog box 52 the reply template contents of the template dialog box 84 (FIG. 11) if it is selected for use. In the first embodiment, the system 10 is operable to store in the database 20 the associations between the social media handle 44 and the created compose-reply dialog box 52, between the social media handle 44 and the given social-media content piece 42, and between the compose-reply dialog box 52 and the hyperlink 54. In the first embodiment, creating the compose-reply dialog box 52 involves displaying the created compose-reply dialog box 52. In the typical example, the compose-reply dialog box 52 is displayed at the given responder Internet device 34 for continued interaction with that system 10 user.

In the first embodiment, the compose-reply dialog box 52 may include any number of hyperlinks other than the hyperlink 54, such as when inserting into the compose-reply dialog box 52 the reply template contents of the template dialog box 84 involves inserting by the system 10 one or more hyperlinks other than the hyperlink 54. The system 10 is also operable in the first embodiment to permit the system 10 user to insert one or more hyperlinks other than the hyperlink 54 into the compose-reply dialog box 52, for example. A hyperlink other than the hyperlink 54 may link to a web page displaying disclaimer text, a privacy policy, etc., for example.

In some embodiments, the compose-reply dialog box 52 need not include the hyperlink 54, such as when the compose-reply dialog box 52 itself includes the “Authorize app” button 64 (FIG. 6) or otherwise has associated therewith functionality for displaying the “Authorize app” button 64 and possibly other parts of the authorization web page 62 (FIG. 6) contents. In some embodiments in which the compose-reply dialog box 52 does not include the hyperlink 54, the compose-reply dialog box 52 may instead include at least one option for making a voice call. In such embodiments, the compose-reply dialog box 52 may include any one or more of the browser-VoIP selection button 70 (FIG. 8), telephone selection button 72 (FIG. 8) and the Skype™ VoIP selection button 74 or otherwise have associated therewith functionality for displaying one or more of the buttons 70 to 74 and possibly other parts of the option-selection web page 68 (FIG. 8) contents. In embodiments not including the hyperlink 54, block 112 need not be executed.

While block 114 of the first embodiment directs the processor 16 to create the compose-reply dialog box 52 in association with the social media handle 44 that is associated with the given social-media content piece 42, in some embodiments the steps of block 106 (FIG. 14) may be implemented without invoking a reply such that posting a replying social-media content piece 58 containing the hyperlink 54 that is associated with the social-media content piece 42 involves posting an originating social-media content piece (not shown) containing any one or more of the hyperlink 54, a prompt for social media credentials, and at least one option for making a voice call. In such embodiments, the originating social-media content piece may be employed to invite one or more participants to participate in a voice call, such as when invitations to participate in a telephonic survey are being disseminated, in the absence of a specific reply to previously published social media content. In such embodiments, either one or both of blocks 110 and 112 may not be executed, for example.

While block 114 of the first embodiment directs the processor 16 to create the compose-reply dialog box 52 for interaction with the system 10 user, in some embodiments the steps of block 106 (FIG. 14) may be more automated such that posting a replying social-media content piece 58 containing the hyperlink 54 that is associated with the social-media content piece 42 involves automatedly populating contents of the replying social-media content piece 58, including the hyperlink 54. In such automated embodiments, the compose-reply dialog box 52 need not be displayed for viewing by the system 10 user.

Block 116 directs the processor 16 to receive a send command directing the processor 16 to send the replying social-media content piece 58. In the typical example, the replying social-media content piece 58 was composed at the given responder Internet device 34 using the compose-reply dialog box 52 such that the hyperlink 54 is maintained as a content of the replying social-media content piece 58, and the send command was issued by invoking the send button 55 (FIG. 4). In some embodiments, receiving the send command involves determining whether the hyperlink 54 remains in the replying social-media content piece 58. In addition or in the alternative to including the hyperlink 54, the replying social-media content piece 58 may include the “Authorize app” button 64, a hyperlink (not shown) other than the hyperlink 54 that functionally represents the “Authorize app” button 64, other related elements, or any combination thereof for example. In addition or in the alternative to including the hyperlink 54, the replying social-media content piece 58 may include at least one option for making a voice call, such as by including any one or more of the browser-VoIP selection button 70, telephone selection button 72 and the Skype™ VoIP selection button 74, including one or more functionally representative hyperlinks, otherwise including functionality for presenting at least one option for making a voice call, or any combination thereof for example.

Block 118 directs the processor 16 to transmit the replying social-media content piece 58 according to the social media handle 44. In the first embodiment, transmitting the replying social-media content piece 58 according to the social media handle 44 involves transmitting the replying social-media content piece 58 from the system 10 via the Internet 12 to one or more social networking services for posting in accordance with such services. In the first embodiment, transmitting the replying social-media content piece 58 involves determining one or more social networking services to which the replying social-media content piece 58 is to be transmitted. Making such determination may involve providing a menu of selectable social networking services at the responder Internet device 34, for example. Such menu may appear in or otherwise be accessible from the settings window 80 (FIG. 11), the compose-reply dialog box 52, other similar windows and dialog boxes of the system 10 user interface, or any combination thereof for example. In some embodiments, determining one or more social networking services to which the replying social-media content piece 58 is to be transmitted involves parsing or otherwise analyzing the social media handle 44 or other information associated with the social-media content piece 42 for identification of one or more social networking services. By way of example, the social media handle 44 “@pheffernanvt” includes the parseable symbol “@” to identify the Twitter™ social networking service. In some embodiments, analyzing the social media handle 44 for identification of one or more social networking services involves analyzing a plurality of social media handles 44 that are associated with the social-media content piece 42.

In the first embodiment, transmitting the replying social-media content piece 58 according to the social media handle 44 involves creating an entry in a voice call history. Typically, creating an entry in the voice call history involves entering the replying social-media content piece 58 into the voice call history. In the first embodiment, entering the replying social-media content piece 58 into the voice call history also includes entering the associated social-media content piece 42 into the voice call history in association with the replying social-media content piece 58. In the first embodiment, the system 10 is operable to display the replying social-media content piece 58 and its associated social-media content piece 42 upon entry into the voice call history in the voice column 56 (FIG. 5) according to display settings of the system 10. In the first embodiment, transmitting the replying social-media content piece 58 according to the social media handle 44 also involves displaying the status indication 60 (FIG. 5) associated with the displayed replying social-media content piece 58.

In the first embodiment, transmitting the replying social-media content piece 58 according to the social media handle 44 also involves storing meta-data associated with the social-media content piece 42 in the database 20. In various embodiments, storing such meta-data involves storing a copy of the social-media content piece 42 itself; the publication date of the social-media content piece 42; the publication time of the social-media content piece 42; keywords located within the social-media content piece 42 selected by the system 10 (e.g. on the basis of an automated linguistic analysis); the associated social media handle(s) 44; identifications of one or more associated social networking services, identification of an individual, group of individuals, business entity, government or other entities associated with the associated social media handle(s) 44; Internet-accessible information about such associated entities; other related information; the replying social-media content piece 58; or any combination thereof for example.

In the first embodiment, the system 10 is operable to store in the database 20 further meta-data at any time that such meta-data becomes available to the system 10. By way of example, the system 10 in the first embodiment is operable to store meta-data related to the subsequent voice call history associated with the social-media content piece 42. In various embodiments, storing such voice call history involves storing a time duration of each of the voice calls of the voice call history; a time elapsed between successive ones of the voice calls of the voice call history; notes associated with the voice calls of the voice call history and associated with their respective call recipients; indications of the identity of each person who terminated each of the voice calls of the voice call history; other related information; or any combination thereof for example.

After executing block 118, the processor 16 is directed to return to the method 104 of FIG. 14.

Referring back to FIG. 14, block 120 directs the processor 16 to detect invocation, by an Internet-capable device (not shown), of the hyperlink 54. Invocation (e.g. mouse-down followed by mouse-up) of the hyperlink 54 may be detected in any suitable manner such as in accordance with standard html programming techniques. In embodiments in which the replying social-media content piece 42 does not include the hyperlink 54, the system 10 is operable to detect action buttons such as any one or more of the “Authorize app” button 64, browser-VoIP selection button 70, telephone selection button 72 and the Skype™ VoIP selection button 74, hyperlinks functionally representative of such one or more buttons 64 and 70 to 74, other functional elements, or any combination thereof for example. In the first embodiment, detecting invocation by block 120 involves directing the processor 16 to update the status of the associated replying social-media content piece 58 from “Idle” to “Opened”.

Block 122 then directs the processor 16 to determine whether authorization is required. Determining whether authorization is required may involve determining whether authorization is required on the basis of the reply type. In the first embodiment, determining whether authorization is required involves determining whether the reply-with-voice menu selection 48 or the DM-with-voice menu selection 50 was received by the system 10 when executing block 110 (FIG. 15). In accordance with the first embodiment, the reply-with-voice menu selection 48 is associated with a requirement for authorization, whereas the DM-with-voice menu selection 50 is associated with no requirement for authorization.

If by block 122 the processor 16 determines that authorization is required, then block 124 directs the processor 16 to prompt for social-media account credentials. In the first embodiment, prompting for social-media account credentials involves displaying the authorization web page 62 or similar at the Internet-capable device (not shown) that was used to invoke the hyperlink 54 (thereafter detected by block 120). In many circumstances, the Internet-capable device used to invoke the hyperlink 54 is the contributor Internet device 26 used to post the associated social-media content piece 42. However, in general, any Internet-capable device (not shown) may be employed to invoke the hyperlink 54 and such Internet-capable device may or may not be associated with the social media account that was used to post the associated social-media content piece 42. Prompting for social-media account credentials advantageously permits the system 10 to verify whether the social media account used to invoke the associated hyperlink 54 is the same as the social media account that was used to post the associated social-media content piece 42. Typically, if the user of the Internet-capable device is satisfied with having their social-media account credentials analyzed for verification purposes, the user will select the “Authorize app” button 64.

While FIG. 14 shows at block 124 the exemplary step of prompting for social-media account credentials, in some embodiments, the system 10 verifies the authenticity of the social media account used to invoke the associated hyperlink 54 by transmitting an authentication request to the social networking service associated with the Internet-capable device (not shown) used to invoke the hyperlink 54 and/or used to invoke the “Authorize app” button 64. Transmitting the authentication request typically involves transmitting the social media handle 44, a copy of or pointer to the social-media content piece 42, or similar identifying information related to the social-media content piece 42. Additionally or alternatively, the system 10 in some embodiments requests authentication from another third-party authenticator. In any event, the system 10 in some embodiments is operable to perform authentication by requesting for and receiving a response indicating whether authentication succeeded or failed, without the system 10 itself making a comparison between the social media handle 44 and the social media account used to invoke the hyperlink 54 and/or the “Authorize app” button 64.

Block 126 then directs the processor 16 to determine whether the social-media account credentials prompted for by block 124 match the social media handle 44 associated with the social-media content piece 42 posted using the contributor's social-media account.

If by block 126 the processor 16 determines that the credentials do not match the social media handle 44, then block 128 directs the processor 16 to display an error message. In the first embodiment, displaying the error message involves presenting the authorization-failed web page 62 (FIG. 7). After executing block 128, the method 104 returns to block 120 such that the system 10 remains operable to detect further invocations of the hyperlink 54. In general, however, the system 10 is operable after displaying the error message by block 128 to resume at any suitable point in the method 100, including at block 124 of FIG. 14 for example.

If by block 126 the processor 16 determines that the credentials match the social media handle 44, then the processor 16 is directed to execute block 130.

Still referring to FIG. 14, if block 122 determines that authorization is not required, then the processor 16 is directed to execute block 130.

Block 130 directs the processor 16 to display at least one technology option at the Internet-capable device (not shown). In accordance with the description herein above in respect of blocks 120 to 128, the Internet-capable device may be the contributor Internet device 26 that was used to post the associated social-media content piece 42, another Internet-capable device being used in association with the associated social media handle 44, or an unassociated Internet-capable device that was used to invoke the hyperlink 54 (e.g. when authorization was not required). In the first embodiment, displaying at least one technology option at the Internet-capable device involves displaying at the Internet-capable device the option-selection web page 68 (FIG. 8).

After block 130 has been executed, the processor 16 is directed to return to the method 100 at block 102.

Referring back to FIG. 13, after block 102 has been executed, the processor 16 is directed to execute block 132.

Block 132 directs the processor 16 to determine the call identification in response to receiving a selection of the at least one technology option.

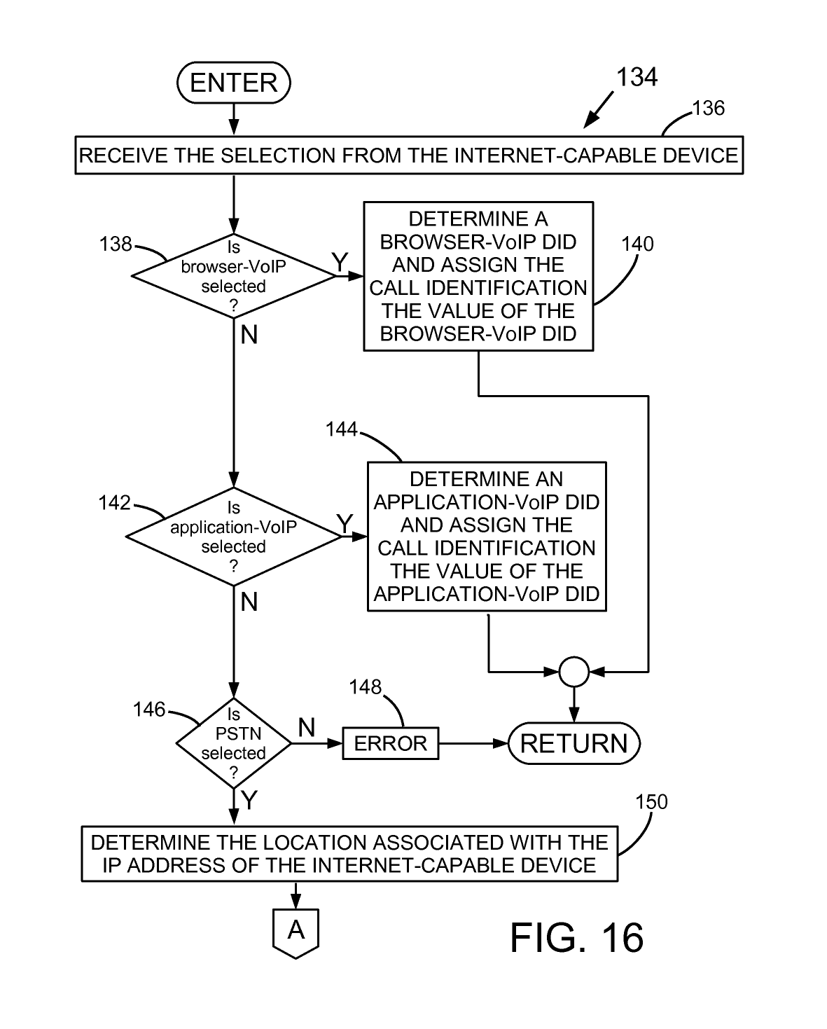

Referring to FIG. 16, an exemplary method for directing the processor 16 to perform steps of block 132 (FIG. 13) is shown generally at 134.

In the method 134, block 136 directs the processor 16 to receive the selection from the Internet-capable device (not shown). In general, the selection or other indication of the selection may be received in any suitable manner such as in accordance with standard html programming techniques.

Block 138 then directs the processor 16 to determine whether browser-VoIP technology is selected. In the first embodiment, determining whether browser-VoIP technology is selected involves determining whether the selection received by block 136 is an indication of browser-VoIP technology. In the first embodiment, determining whether browser-VoIP technology is selected involves determining whether the browser-VoIP selection button 70 (FIG. 8) has been invoked. For example, determining whether browser-VoIP technology is selected involves in the first embodiment determining whether the selection received by block 136 is an indication that the browser-VoIP selection button 70 (FIG. 8) has been invoked.

If by block 138 the processor 16 determines that browser-VoIP technology is selected, then the processor 16 is directed to execute block 140.

Block 140 directs the processor 16 to determine a browser-VoIP DID (Direct Inward Dialing) and assign the call identification the value of the browser-VoIP DID. In the first embodiment, determining a browser-VoIP DID involves obtaining a VoIP-compatible DID or other VoIP destination address suitable for use with voice calls that are receivable by the system 10 as an incoming browser-based VoIP call. Obtaining a browser-VoIP DID in the first embodiment involves retrieving the browser-VoIP DID from the database 20. Typically, browser-VoIP DIDs are created in advance and stored in the database 20 for subsequent use. However, in some embodiments browser-VoIP DIDs are purchased or otherwise created on an immediate as-needed basis. In the first embodiment, assigning the call identification the value of the browser-VoIP DID involves creating an association between the browser-VoIP DID and the associated social-media content piece 42. In some embodiments, assigning the call identification the value of the browser-VoIP DID involves storing the association between the browser-VoIP DID and the associated social-media content piece 42 in the database 20.

If by block 138 the processor 16 determines that browser-VoIP technology is not selected, then the processor 16 is directed to execute block 142.

Block 142 directs the processor 16 to determine whether application-VoIP technology is selected. In the first embodiment, determining whether application-VoIP technology is selected involves determining whether the selection received by block 136 is an indication of application-VoIP technology. In the first embodiment, determining whether application-VoIP technology is selected involves determining whether the Skype™ VoIP selection button 74 (FIG. 8) has been invoked. For example, determining whether application-VoIP technology is selected involves in the first embodiment determining whether the selection received by block 136 is an indication that the Skype™-VoIP selection button 74 (FIG. 8) has been invoked. While FIG. 8 shows the exemplary Skype™-VoIP selection button 74, in general the application-VoIP technology may employ any suitable application-based VoIP software supplied by any entity under any brand name.

If by block 142 the processor 16 determines that application-VoIP technology is selected, then the processor 16 is directed to execute block 144.

Block 144 directs the processor 16 to determine an application-VoIP DID (Direct Inward Dialing) and assign the call identification the value of the application-VoIP DID. Block 144 may be executed in a manner analogous to block 144 such that an association between the application-VoIP DID and the associated social-media content piece 42 is created, including possibly storing such association in the database 20.

If by block 142 the processor 16 determines that application-VoIP technology is not selected, then the processor 16 is directed to execute block 146.

Block 146 directs the processor 16 to determine whether PSTN technology is selected. In the first embodiment, determining whether PSTN technology is selected involves determining whether the selection received by block 136 is an indication of PSTN technology. In the first embodiment, determining whether PSTN technology is selected involves determining whether the telephone selection button 72 (FIG. 8) has been invoked. For example, determining whether PSTN technology is selected involves in the first embodiment determining whether the selection received by block 136 is an indication that the telephone selection button 72 (FIG. 8) has been invoked.

If by block 146 the processor 16 determines that PSTN technology is not selected, then the processor 16 is directed to execute block 148.

Block 148 directs the processor 16 to perform error handling. In the first embodiment, the processor 16 is directed to execute error handling when the system 10 has received the selection by block 136 which does not correspond to any one of browser-VoIP selection button 70, telephone selection button 72, and the Skype™ VoIP selection button 74. In some embodiments, however, block 148 directs the processor 16 to assign the call identification a value on the basis of a voice calling technology other than shown in FIG. 8. By way of example, the system 10 is operable in some embodiments to support a variety of application-VoIP technologies from a variety of VoIP application providers.

If by block 146 the processor 16 determines that PSTN technology is selected, then the processor 16 is directed to execute block 150.

Block 150 directs the processor 16 to determine the location associated with the IP (Internet Protocol) address of the Internet-capable device. The IP address of the Internet-capable device may be determined in any suitable manner, including known techniques relating to Internet technology. In the first embodiment, determining the location associated with the IP address of the Internet-capable device involves retrieving geographical location information from the database 20. Such location information may include a country, region and city for example. Additionally or alternatively, determining the location associated with the IP address of the Internet-capable device may involve querying an independent IP address map lookup service, for example.

When block 150 has been executed, the processor 16 is directed to execute block 152.

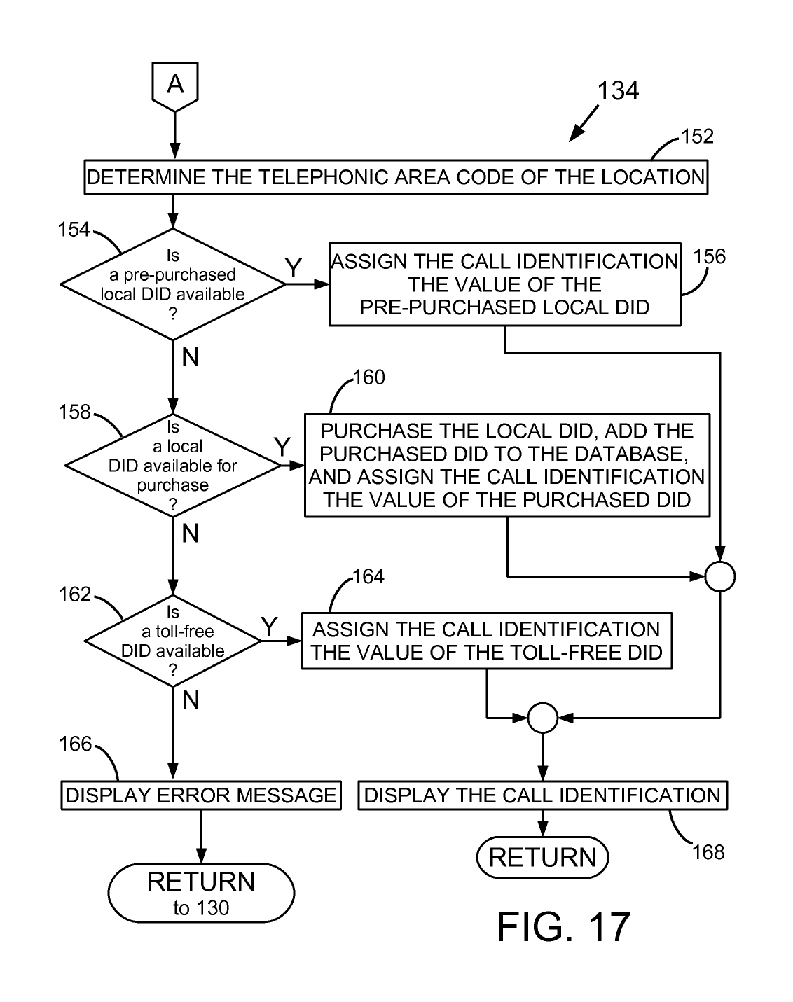

Referring to FIG. 17, block 152 directs the processor 16 to determine the telephonic area code of the location. In the first embodiment, determining the telephonic area code of the location involves retrieving telephonic area code information from the database 20. Additionally or alternatively, determining the telephonic area code of the location may involve querying an independent telephonic area code lookup service, for example. Typically, telephonic area codes are associated with locations in accordance with a known telecommunications standard such as the E.164 numbering plan, for example.

Block 154 then directs the processor 16 to determine whether a pre-purchased local DID is available. In the first embodiment, determining whether a pre-purchased local DID is available involves querying the database 20 for a stored DID (i.e. telephone number for use with the PSTN 14) which is available (i.e. not already assigned to a call identification) and would permit a person located in the geographical location determined by block 150 and having the telephonic area code determined by block 152 to make a local, rather than a long-distance, telephone call to the pre-purchased local DID.

If by block 154 the processor 16 determines that a pre-purchased local DID is available, then the processor 16 is directed to execute block 156.

Block 156 directs the processor 16 to assign the call identification the value of the pre-purchased local DID. In the first embodiment, assigning the call identification the value of the pre-purchased local DID involves creating an association between the pre-purchased local DID and the associated social-media content piece 42. In some embodiments, assigning the call identification the value of the pre-purchased local DID involves storing the association between the pre-purchased local DID and the associated social-media content piece 42 in the database 20.

If by block 154 the processor 16 determines that a pre-purchased local DID is not available, then the processor 16 is directed to execute block 158.

Block 158 directs the processor 16 to determine whether a local DID is available for purchase. In the first embodiment, determining whether a local DID is available for purchase involves requesting a DID from a DID provider. Requesting the DID from a DID provider involves requesting a DID that is available for purchase and would permit a person located in the geographical location determined by block 150 and having the telephonic area code determined by block 152 to make a local, rather than a long-distance, telephone call to the local DID if purchased.

If by block 158 the processor 16 determines that a local DID is available for purchase, then the processor 16 is directed to execute block 160.

Block 160 directs the processor 16 to purchase the local DID that was determined by block 158 to be available for purchase; add the purchased DID to the database 20; and assign the call identification the value of the purchased DID. Purchasing the local DID may be implemented in any suitable manner, including employing known technologies for interfacing with one or more DID providers for purchasing DIDs. In the first embodiment, assigning the call identification the value of the purchased DID involves creating an association between the purchased DID and the associated social-media content piece 42. In some embodiments, assigning the call identification the value of the purchased DID involves storing the association between the purchased DID and the associated social-media content piece 42 in the database 20.

If by block 158 the processor 16 determines that a local DID is not available for purchase, then the processor 16 is directed to execute block 162.

Block 162 directs the processor 16 to determine whether a toll-free DID is available. In the first embodiment, determining whether a toll-free DID is available involves querying the database 20 for a stored DID (i.e. telephone number for use with the PSTN 14) which is available (i.e. not already assigned to a call identification) and would permit a person located in the geographical location determined by block 150 and having the telephonic area code determined by block 152 to make a toll-free, albeit long-distance, telephone call to the toll-free DID.

If by block 162 the processor 16 determines that a toll-free DID is available, then the processor 16 is directed to execute block 164.

Block 164 directs the processor 16 to assign the call identification the value of the toll-free DID. In the first embodiment, assigning the call identification the value of the toll-free DID involves creating an association between the toll-free DID and the associated social-media content piece 42. In some embodiments, assigning the call identification the value of the toll-free DID involves storing the association between the toll-free DID and the associated social-media content piece 42 in the database 20.

If by block 162 the processor 16 determines that a toll-free DID is not available, then the processor 16 is directed to execute block 166.

Block 166 directs the processor 16 to display an error message. Displaying the error message may involve displaying at the Internet-capable device (not shown) from which the selection was received by block 136 (FIG. 16) an indication that a PSTN telephone number is not currently available, and possibly requesting that another selection be made or that the same selection be made at a later time.

When block 166 has been executed, the processor 16 is directed to return to the method 104 (FIG. 14) at block 130. Returning the process to block 130 advantageously presents again the at least one technology option to permit a subsequent selection to be made. In general, however, the processor 16 may be directed to return to any suitable block of the method 100 (FIG. 13).

Still referring to FIG. 17, after any one of blocks 156, 160 and 164 have been executed, the processor 16 is directed to execute block 168.

Block 168 directs the processor 16 to display the call identification. In the first embodiment, displaying the call identification involves displaying the telephone number 76 (FIG. 9) as may have been determined by block 156, 160 or 164.

After block 168 has been executed, the processor 16 is directed to return to the method 100 at block 132.

Referring back to FIG. 13, after block 132 has been executed, the processor 16 is directed to execute block 170.

Block 170 directs the processor 16 to forward the voice call, which may be an audio-only call or a video call for example, to a call recipient.

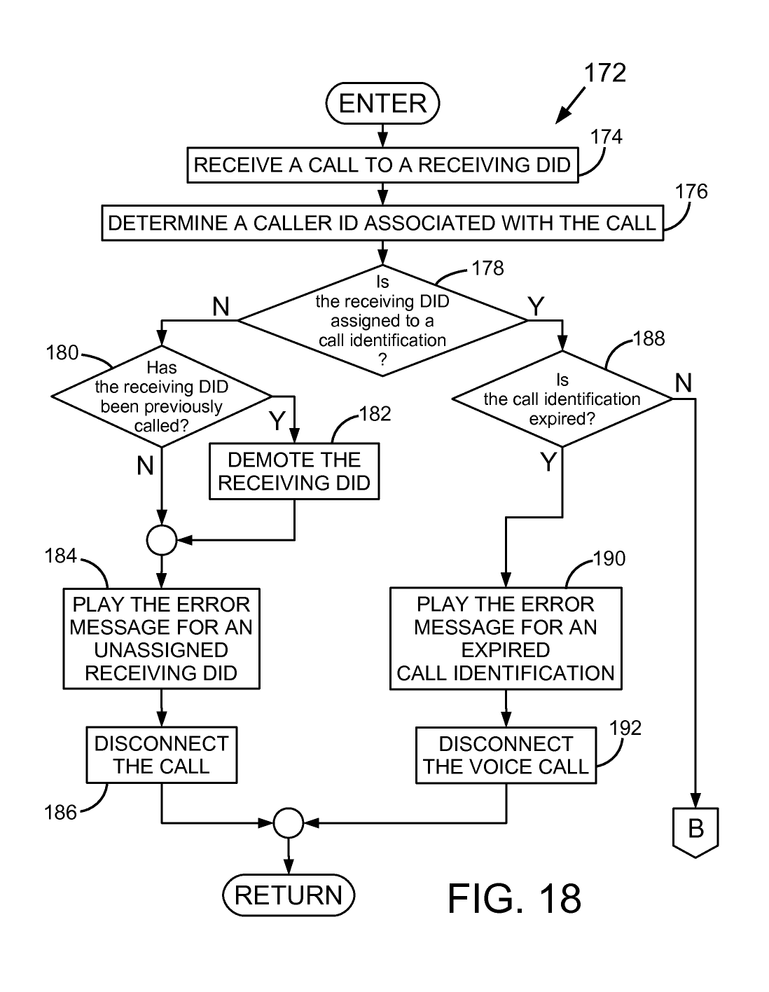

Referring to FIG. 18, an exemplary method for directing the processor 16 to perform steps of block 170 (FIG. 13) is shown generally at 172.

In the method 172, block 174 directs the processor 16 to receive a call to a receiving DID. In the first embodiment, receiving a call to a receiving DID involves receiving a call by any technological means, including browser-VoIP, application-VoIP and PSTN technologies. In the first embodiment, receiving a call to a receiving DID involves receiving a call to any DID that is receivable by the system 10, such as being any one of the browser VoIP DIDs, application-VoIP DIDs, pre-purchased local DIDs, purchased DIDs or toll-free DIDs stored in the database 20 for example.

Block 176 then directs the processor 16 to determine a caller ID (identification) associated with the call. Typically, the caller ID is an identification associated with a device (not shown) being used to make the call to the receiving DID, including an identification associated with an account with a telecommunications provider, which may be a telephone service provider or a VoIP service provider for example, being used to make the call. Determining a caller ID associated with the call may involve any suitable technique including employing known technologies related to caller identification. While not shown in FIG. 18, in the case of the caller ID information being blocked or otherwise unavailable the system 10 is operable to disconnect the call, including playing an error message and then disconnecting the call, or to forward the call in the absence of having the caller ID information, such as forwarding the call to a publicly available general customer service telephone number for example.

Block 178 then directs the processor 16 to determine whether the receiving DID is assigned to a call identification. In the first embodiment, determining whether the receiving DID is assigned to a call identification involves querying the database 20 to determine whether the value of any of the call identifications associated with a social-media content piece 42 matches the value of the receiving DID. If there is a match, the match indicates that call identification was previously assigned the value of the receiving DID.

If by block 178 the processor 16 determines that the receiving DID has not been assigned to a call identification, then the processor 16 is directed to execute block 180 for continued management of the call received to the unassigned DID.

Block 180 directs the processor 16 to determine whether the receiving DID has been previously called. In the first embodiment, determining whether the receiving DID has been previously called involves querying the database 20 for previously stored information related to the receiving DID, such as the call-receipt history of the receiving DID.

If by block 180 the processor 16 determines that the receiving DID has been previously called, the processor 16 is directed to execute block 182.

Block 182 directs the processor 16 to demote the receiving DID. In the first embodiment, demoting the receiving DID involves placing the receiving DID at the lowest position within an ordered list of receiving DIDs associated with the same voice technology and the same telephonic area code, if applicable. In variations, the receiving DID may be demoted by placing the receiving DID at a lower position, or otherwise inhibiting the receiving DID from being selected for being assigned to a call identification for a limited or indefinite time period while the unassigned receiving DID is still receiving calls. Demoting unassigned DIDs advantageously inhibits receiving DIDs which are improperly receiving calls from being selected for use with a legitimate call identification. In some embodiments, the system 10 is operable to subsequently restore a demoted receiving DID, such as when a demoted receiving DID has not received a call for a specifiable period of time.

While FIG. 18 shows that a given unassigned receiving DID is demoted upon receiving a second call and at each subsequent call thereafter, in some embodiments the system 10 is operable to demote an unassigned receiving DID upon being called for a first time. In variations, demotion by block 182 may occur upon the unassigned DID receiving any specifiable number of calls.

After block 182 has been executed, the processor 16 is directed to execute block 184.

Still referring to FIG. 18, if by block 180 the processor 16 determines that the receiving DID has not been previously called, the processor 16 is directed to execute block 184.

Block 184 directs the processor 16 to play an error message for an unassigned receiving DID. In the first embodiment, playing an error message for an unassigned receiving DID involves playing an audio clip stating that an error has occurred (e.g. “This number is not currently in use.”). After block 184 has been executed, the processor 16 is directed to execute block 186.

Block 186 directs the processor 16 to disconnect the call.

Still referring to FIG. 18, if by block 178 the processor 16 determines that the receiving DID has been assigned to a call identification, then the processor 16 is directed to execute block 188 for continued management of the voice call associated with the call identification.

Block 188 directs the processor 16 to determine whether the call identification is expired. In the first embodiment, determining whether the call identification is expired involves determining whether a previously defined expiration limit associated with the call identification is exceeded. In variations, expiration limits may include a maximum number of times the associated hyperlink 54 may be invoked; a maximum number of times the call identification may be used to complete a voice call; a maximum period of elapsed time since a most recent previous voice call associated with the call identification; a maximum period of elapsed time between the most recent previous invocation of the hyperlink 54 and receiving the voice call associated the call identification; a maximum total duration of time spent during all previous voice calls associated with the call identification; a maximum total duration of time spent during all voice calls associated with the call identification; a maximum duration of time spent during any single previous voice call associated with the call identification; a maximum duration of time spent during any single voice call associated with the call identification; other expiration limits; or any combination thereof for example. Additionally or alternatively, determining whether the call identification is expired involves in the first embodiment determining whether the call identification has been forced into expiry in accordance with user input received from a system 10 user.

If by block 188 the processor 16 determines that the call identification is expired, then the processor 16 is directed to execute block 190.

Block 190 directs the processor 16 to play an error message for an expired call identification. In the first embodiment, playing an error message for an unassigned receiving DID involves playing an audio clip stating that the call identification (e.g. “This number is no longer in use.”). While FIG. 18 shows blocks 184 and 190 as executing separately, in some embodiments the processor 16 is directed to play the same error message in both situations (e.g. “This number is not in use.”). After block 190 has been executed, the processor 16 is directed to execute block 192.

Block 192 directs the processor 16 to disconnect the voice call.

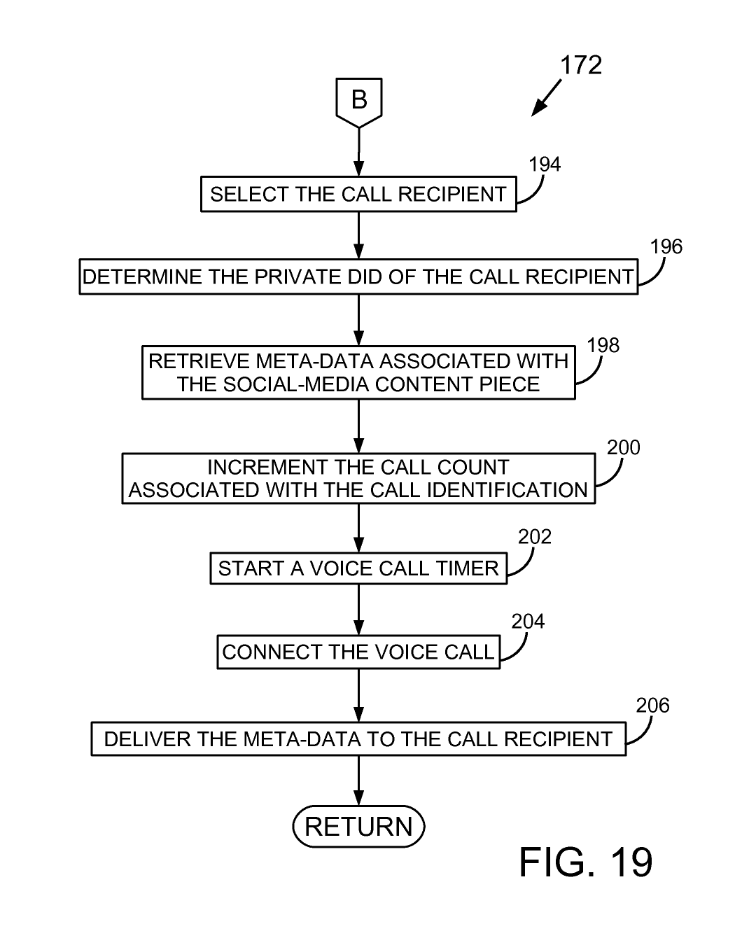

Referring to FIGS. 18 and 19, if by block 188 the processor 16 determines that the call identification is not expired, then the processor 16 is directed to execute block 194 for continued management of the voice call associated with the unexpired call identification.

Block 194 directs the processor 16 to select the call recipient. In a variation, selecting the call recipient may involve selecting the call recipient in accordance with a pre-determined association between the call recipient and any one or more of the social-media content piece 42, the replying social-media content piece 58, and the voice call history for example. For example, selecting the call recipient may involve selecting the call recipient associated with the responder Internet device 34 used to invoke the send button 55 (FIG. 4) to create the replying social-media content piece 58 associated with the voice call. Additionally or alternatively, selecting the call recipient may involve dynamically selecting the call recipient, such as on an availability basis, for example. In some embodiments, the call recipient is selected as the next available entry in an ordered list. In variations, the call recipient may be a human (e.g. customer service agent), an automated voice call receiving system, an automated voice call receiving portion of the system 10, or any combination thereof for example.

Block 196 then directs the processor 16 to determine the private DID of the selected call recipient. In the first embodiment, determining the private DID of the call recipient involves querying the database 20 for the private DID. In some embodiments, each call recipient is identified by their private DID such that the private DID of the call recipient is determined by block 194, in which case block 196 may be skipped. Determining the private DID by block 196 and/or 194 advantageously permits the system 10 to forward the voice call to the call recipient without revealing to the caller the private DID of the call recipient.

Block 198 then directs the processor 16 to retrieve meta-data associated with the social-media content piece 42. In the first embodiment, retrieving the meta-data associated with the social-media content piece 42, and hence associated with the voice call, involves retrieving the meta-data from the database 20.

Block 200 then directs the processor 16 to increment the call count associated with the call identification. Incrementing the call count advantageously maintains an accurate count within the associated voice call history of the meta-data so as to facilitate accurately determining whether the call identification is expired upon receiving a subsequent voice call associated with the same call identification.

Block 202 then directs the processor 16 to start a voice call timer. Starting the voice call timer advantageously facilitates maintaining an accurate record of the duration of the voice call so as to facilitate accurately determining whether the call identification is expired upon receiving a subsequent voice call associated with the same call identification.

Block 204 then directs the processor 16 to connect the voice call, which may be an audio-only call or a video call for example. In the first embodiment, forwarding the voice call involves forwarding the voice call to the selected call recipient.

Block 206 then directs the processor 16 to deliver the meta-data to the call recipient. In the first embodiment, delivering the meta-data to the call recipient involves delivering the meta-data associated with the voice call to the call recipient. In some embodiments, delivering the meta-data to the call recipient involves delivering the meta-data in accordance with pre-defined system 10 user preferences. For example, individual or group administrative settings may define the meta-data be displayed on a specifiable computing device associated with each call recipient. In some embodiments, delivering the meta-data to the call recipient involves delivering the meta-data in accordance with a device type associated with the call recipient. For example, delivering the meta-data to the call recipient may involve performing a text-to-speech conversion in the case where the voice call is being forwarded to a mobile phone.

After block 206 has been executed, the processor 16 is directed to return to the method 100 at block 170.

Referring back to FIG. 13, after block 170 has been executed, the processor 16 is directed to end the method 100.

While FIGS. 13 to 19 shows steps of the method 100 in an exemplary order, the system 10 is operable in the first embodiment to execute the blocks 102 to 206 in orders other than shown in FIGS. 13 to 19. For example, after detecting invocation of the hyperlink 54 by block 120 of FIG. 14, the system 10 continues to be operable to detect subsequent invocations of the hyperlink 54 which may occur at any time. Also, after receiving the selection by block 136 of FIG. 16, the system 10 continues to be operable to receive subsequent selections in association with any of the browser-VoIP selection button 70, the telephone selection button 72 and the Skype™ VoIP selection button 74 as such subsequent selections may occur at any time and in any order for example.

Thus, there is provided a method of managing voice calls in association with social media content, the method comprising: (a) presenting, in response to a social-media content piece, at least one option for making a voice call having a call identification associated with said social-media content piece; (b) determining, in response to receiving a selection of said at least one option, said call identification; and (c) forwarding said voice call to a call recipient.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. A computer-implemented method of managing voice calls in association with social media content, the method comprising:
(a) in response to a social-media content piece, posting a replying social-media content piece containing a hyperlink for presenting at least one option for making a voice call having a call identification associated with said social-media content piece;
(b) determining said call identification in response to receiving a selection of said at least one option; and
(c) forwarding said voice call to a call recipient.

2. The method of claim 1 wherein posting a replying social-media content piece containing a hyperlink for presenting at least one option for making a voice call having a call identification associated with said social-media content piece comprises: detecting an invocation of said hyperlink by an Internet-capable device; determining whether authorization is required to forward said voice call; and obtaining social-media account credentials associated with said invocation if said authorization is required.

3. The method of claim 1 wherein posting a replying social-media content piece containing a hyperlink for presenting at least one option for making a voice call having a call identification associated with said social-media content piece comprises presenting at least one of a first option for making said voice call using a browser-based VoIP technology and a second option for making said voice call using an application-based VoIP technology.

4. The method of claim 1 wherein posting a replying social-media content piece containing a hyperlink for presenting at least one option for making a voice call having a call identification associated with said social-media content piece comprises presenting a third option for making said voice call using a PSTN technology.

5. The method of claim 3 wherein posting a replying social-media content piece containing a hyperlink for presenting at least one option for making a voice call having a call identification associated with said social-media content piece comprises presenting a third option for making said voice call using a PSTN technology.

6. The method of claim 5 wherein presenting at least one of a first option for making said voice call using a browser-based VoIP technology and a second option for making said voice call using an application-based VoIP technology comprises presenting said first and second options.

7. The method of claim 2 wherein determining said call identification in response to receiving a selection of said at least one option comprises determining a location associated with the IP address of said Internet-capable device and determining whether at least one of a local DID and a toll-free DID is available.

8. The method of claim 7 further comprising displaying said call identification at said Internet-capable device.

9. The method of claim 1 wherein forwarding said voice call to a call recipient comprises receiving a call to a receiving DID, determining whether said receiving DID is assigned to an unexpired call identification, determining a private DID associated with said call recipient, and connecting said voice call.

10. The method of claim 9 wherein forwarding said voice call to a call recipient comprises determining a caller ID associated with said call.

11. The method of claim 9 wherein forwarding said voice call to a call recipient comprises preventing said receiving DID from being assigned until after the elapse of a specifiable time during which no calls to said receiving DID are received.

12. The method of claim 9 wherein determining whether said receiving DID is assigned to an unexpired call identification comprises at least one of: determining whether the number of times said hyperlink has been invoked exceeds a pre-determined hyperlink invocation limit; determining whether a call count of the number of times said call identification has been used for a completed call exceeds a pre-determined call count limit; determining whether the time elapsed since a most recent previous voice call associated with said call identification exceeds a pre-determined previous-call time limit; determining whether the time elapsed between a most recent previous invocation of said hyperlink and said voice call exceeds a pre-determined hyperlink-to-call time limit; determining whether the total duration of time spent during all voice calls previously made in association with said call identification exceeds a pre-determined total call time limit; determining whether the duration of the most recent previous voice call associated with said call identification exceeds a pre-determined maximum call time limit; and determining whether a command to expire said call identification has been received.

13. The method of claim 1 wherein forwarding said voice call to a call recipient comprises delivering meta-data associated with said social-media content piece to at least one of said call recipient and an auxiliary device associated with said call recipient.

14. The method of claim 13 wherein delivering to said call recipient meta-data associated with said social-media content piece comprises delivering at least one of: identification information associated with said social-media content piece; a social media handle associated with said social-media content piece; an image associated with said social-media content piece; Internet-accessible information associated with said social-media content piece; a publication time associated with said social-media content piece; a publication date associated with said social-media content piece; a voice call history associated with said social-media content piece; and notes associated with previous voice calls of said voice call history.

15. A computer-implemented system for managing voice calls in association with social media content, the system comprising:
(a) a first system component for posting, in response to a social-media content piece, a replying social-media content piece containing a hyperlink for presenting at least one option for making a voice call having a call identification associated with said social-media content piece;
(b) a second system component for determining said call identification in response to receiving a selection of said at least one option; and
(c) a third system component for forwarding said voice call to a call recipient.

16. The system of claim 15 wherein said third system component is operable to retrieve meta-data associated with said social-media content piece and to deliver said meta-data to at least one of said call recipient and an auxiliary device associated with said call recipient when forwarding said voice call.

17. A computer-implemented system for managing voice calls in association with social media content, the system comprising:
(a) means for posting, in response to a social-media content piece, a replying social-media content piece containing a hyperlink for presenting at least one option for making a voice call having a call identification associated with said social-media content piece;
(b) means for determining said call identification in response to receiving a selection of said at least one option; and
(c) means for forwarding said voice call to a call recipient.

18. The system of claim 17 further comprising means for obtaining social-media account credentials associated with an invocation of said hyperlink when authorization is required.

19. The system of claim 17 wherein means for determining said call identification in response to receiving a selection of said at least one option comprises means for determining a PSTN DID.

20. The system of claim 17 wherein means for forwarding said voice call to a call recipient comprises means for retrieving meta-data associated with said social-media content piece and delivering said meta-data at least one of said call recipient and an auxiliary device associated with said call recipient.
